(19) United States
(12) Patent Application Publication
(10) Pub. No.: US 2026/0236326 A1
(43) Pub. Date: Aug. 13, 2026

(54) Layered Concurrency Management

(71) Applicant: Oracle International Corporation, Redwood Shores, CA (US)

(72) Inventor: Erik Österlund, Vasterhaninge (SE)

(73) Assignee: Oracle International Corporation, Redwood Shores, CA (US)

(21) Appl. No.: 19/539,358

(22) Filed: Feb. 13, 2026

Related U.S. Application Data
(60) Provisional application No. 63/758,279, filed on Feb. 13, 2025.

(51) Int. Cl. G06F 9/52

(52) U.S. Cl. CPC G06F 9/52

(57) ABSTRACT

Concurrency management techniques are disclosed. The system organizes runtime memory into a higher layer associated with a safety-intensive policy and a lower layer associated with a performance-intensive policy. While threads are creating data structures in runtime memory pursuant to requests from a program instance, the system directs these threads to color pointers referencing these data structures to track what layer of runtime memory these data structures respectively correspond to. Accordingly, when a thread interacts with a pointer that refers to a data structure while executing a request, the thread can readily identify the applicable concurrency management policy. For instance, based on the coloring of pointers, a thread can identify a request attempting to cross between the layers of runtime memory, and the thread can apply the appropriate concurrency management policy to ensure that this request does not compromise the higher-layer safety guarantees or the lower-layer performance advantages.

### INCORPORATION BY REFERENCE; DISCLAIMER

Each of the following applications and any parent patent applications (provisionals, non-provisionals, international, and foreign) to which this application claims priority to, directly or indirectly, are hereby incorporated by reference in their entirety to the same extent as if fully and explicitly recited herein. Any incorporation by reference is limited such that no subject matter is incorporated that is contrary to the explicit disclosure herein. The applications being incorporated by reference include at least: U.S. Application No. 63/758,279 filed on Feb. 13, 2025.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to concurrent computing architectures. In particular, the present disclosure relates to implementing concurrency safety in concurrent computing environments.

### BACKGROUND

With respect to a computing architecture, the term “concurrency” refers to the ability of a computing system to perform multiple tasks simultaneously and/or the ability of the computing system to perform multiple tasks in overlapping time periods. As used herein, the term “task” refers to one or more related computing operations. Performing tasks concurrently can improve the efficiency and performance of a computing system. However, concurrency can also give rise to an issue that results from one task interfering with another task that is being performed concurrently (referred to herein as a “concurrency issue”). Example concurrency issues include data races, nondeterministic behavior, memory corruption, lost updates, livelock, deadlock, resource starvation, priority inversion, thread thrashing, undefined program behavior, security risks, and others.

A concurrency issue can result from conflicting accesses to the same location in memory. For example, if two threads of execution are concurrently performing tasks that involve accessing the same shared data structure, and if one of the threads is attempting to mutate this shared data structure, a concurrency issue may arise. As used herein, the term “shared data structure” refers to a data structure accessible to multiple independent processes and/or subcomponents of processes. A runtime object is an example of a data structure that may exist in runtime memory, and a shared object (i.e., a shared, runtime object) is an example of a shared data structure. Conversely, the term “private data structure” refers to a data structure that is not accessible to multiple independent processes and/or subcomponents of processes. The verb “mutate” refers to changing the state of a data structure, and the noun “mutator” refers to a process and/or a subcomponent of that process that is attempting to mutate a data structure. A thread of execution that writes a new value to a data structure is an example of a mutator. The term “thread of execution” is used herein to identify a subcomponent of a process. For brevity, a thread of execution may be referred to herein simply as a “thread.” Two threads that access a shared data structure in a conflicting manner may be constituents of the same process, or those two threads may be constituents of two different processes. In the example context of multiple threads collaboratively executing the same program instance, conflicting accesses to the same memory location are often the result of a causality bug in the program instance. A program may, for example, include a causality bug if a programmer fails to correctly establish or maintain the relationship between cause and effect in the logic of the program.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced in accordance with one or more embodiments;

FIG. 2 is a block diagram illustrating an example computer system suitable for implementing methods and features described herein in accordance with one or more embodiments;

FIG. 3 illustrates an example virtual machine memory layout in block diagram form in accordance with one or more embodiments;

FIG. 4 illustrates an example frame in block diagram form in accordance with one or more embodiments;

FIG. 5 is a block diagram illustrating a system for practicing techniques described herein in accordance with one or more embodiments;

FIG. 6 illustrates an example set of operations for layered concurrency management in accordance with one or more embodiments;

FIG. 7A, FIG. 7B, and FIG. 7C illustrate a simplified example of a runtime memory 700 where techniques for layered memory management may be practiced in accordance with an example embodiment; and

FIG. 8 illustrates a computer system in block diagram form in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
2.1 EXAMPLE CLASS FILE STRUCTURE
2.2 EXAMPLE VIRTUAL MACHINE ARCHITECTURE
2.3 LOADING, LINKING, AND INITIALIZING
3. CONCURRENCY MANAGEMENT SYSTEM
4. LAYERED CONCURRENCY MANAGEMENT SYSTEM
5. EXAMPLE EMBODIMENT
6. PRACTICAL APPLICATIONS, ADVANTAGES, AND IMPROVEMENTS
7. HARDWARE OVERVIEW
8. MISCELLANEOUS; EXTENSIONS

### 1. GENERAL OVERVIEW

One or more embodiments organize runtime memory into a subdivision that is configured for greater concurrency safety and another subdivision that is configured for better program performance. A logical subdivision that is configured for greater concurrency safety is referred to herein as a “higher layer” of runtime memory, and a logical subdivision that is configured for better program performance is referred to herein as a “lower layer” of runtime memory. The system facilitates the creation, maintenance, and traversal of pointers between data structures in the higher layer and data structures in the lower layer so that a program instance that is allocated runtime memory can simultaneously rely on the higher layer for task that warrant prioritizing concurrency safety and the lower layer for tasks that warrant prioritizing program performance. To this end, the system colors pointers that potentially (a) originate from data structures residing in one of the layers of runtime memory and (b) refer to other data structure residing in the opposing layer of runtime memory. As used herein, the term “pointer” refers to a set of bits that is at least partially allocated for storing an address of a memory location. Note that a pointer may include more bits than are needed to store an address of a memory location. As used herein, the term “address bits” refers to the bit(s) in a pointer that are allocated for storing an address of a memory location, the term “non-address bits” refers to bit(s) in a pointer that are not being utilized to store an address of a memory location, and the phrase “coloring a pointer” refers to encoding metadata into the non-address bits of the pointer. Here, the metadata that is being encoded into pointers is used as an input for barrier logic. As used herein, the term “barrier” refers to an additional set of executable instructions that is inserted into the executable instructions of a program instance. Barriers are utilized by the system as a mechanism for policing interactions between the opposing layers of runtime memory. In particular, the system employs barriers to ensure that (a) interactions originating from the lower layer of runtime memory do not unravel the concurrency safety mechanisms of the higher layer of runtime memory and (b) interactions originating from the higher layer of runtime memory do not dilute the performance advantages of the lower layer of runtime memory.

One or more organize runtime memory into a higher layer that is associated with a safety-intensive concurrency management policy (referred to herein as a “safety-intensive policy”) and a lower layer that is associated with a performance-intensive concurrency management policy (referred to herein as a “performance-intensive policy”). The safety-intensive policy requires interactions with shared data structures to be performed indirectly. For instance, the requests that are subject to the performance-policy may be prevented from directly interacting with shared data structures. Instead, the performance-intensive policy may stipulate that execution of requests targeting shared data structures are redirected to isolated copies of these shared data structures. By redirecting the execution of these requests to operate on the isolated copies, the system may avoid concurrency issues that could otherwise arise if the thread executed these requests directly on the shared data structures while another thread was concurrently manipulating these same shared data structures. Redirecting the execution of a request targeting one copy of a data structure to instead operate on another copy of this data structure may be referred to herein as “staging” the execution of this request. In addition to staging the execution of requests targeting shared data structures, the performance-intensive policy may call for threads executing requests to track a version history of the shared data structures and a version history of the staged copies of these shared data structures. These version histories serve as a basis for implementing other concurrency-safety mechanisms, such as concurrency checks and synchronization processes, which are specified by the performance-intensive policy. The concurrency-safety mechanisms specified by the performance-intensive policy provide robust safety guarantees for requests that warrant greater concurrency safety. At the same time, a program instance may leverage the lower layer of runtime memory for requests that warrant faster program execution. For instance, after staging the execution of a safety-critical request in the higher layer, a thread may cross into the lower layer where the less rigorous concurrency-safety mechanisms specified by the performance-intensive policy may allow the thread to directly interact with shared data structures, thereby increasing program performance.

One or more embodiments organize runtime memory into a higher layer that is associated with a safety-intensive policy and a lower layer that is associated with a performance-intensive policy. While threads are creating data structures in runtime memory at the behest of a program instance, barriers instruct these threads to color pointers that refer to these data structures. For instance, a barrier imposed on a thread may direct the thread to color a pointer to a data structure to indicate if this data structure resides in the lower layer or the higher layer. When a thread subsequently encounters a colored pointer while executing a request of a program instance, the thread can readily ascertain what layer the data structure referenced by this colored pointer resides in based on the metadata encoded into the colored pointer. Based on the coloring of pointers leading to a data structure that is targeted by a request, a thread can readily determine what concurrency management policy should be applied to this request. For instance, if a request is attempting to load or store a primitive value to a data structure, then a barrier may direct the thread to (a) identify the layer in which this data structure resides in based on the coloring of a pointer that refers to this data structure and (b) apply the concurrency management policy corresponding to this layer. If a request is attempting to load or store a pointer, then a barrier may direct a thread to identify (a) the layer that this pointer is being loaded from or stored to and (b) the layer that is pointer refers to. If the pointer is being loaded from or stored to the same layer that is referenced by the pointer, then barrier instructs the thread to apply the concurrency management policy that corresponds to this layer. On the other hand, if the pointer (a) is being loaded from or stored to one layer and (b) references the other layer, then the barrier may instruct the thread to apply the safety-intensive policy which includes concurrency-safety mechanisms that ensure (a) pointers originating from the lower layer do not unravel the safety guarantees of the higher layer and (b) pointers originating from the higher layer do not dilute the performance advantages of the lower layer.

One or more embodiments described in this Specification and/or recited in the Claims may not be included in this General Overview section.

### 2. ARCHITECTURAL OVERVIEW

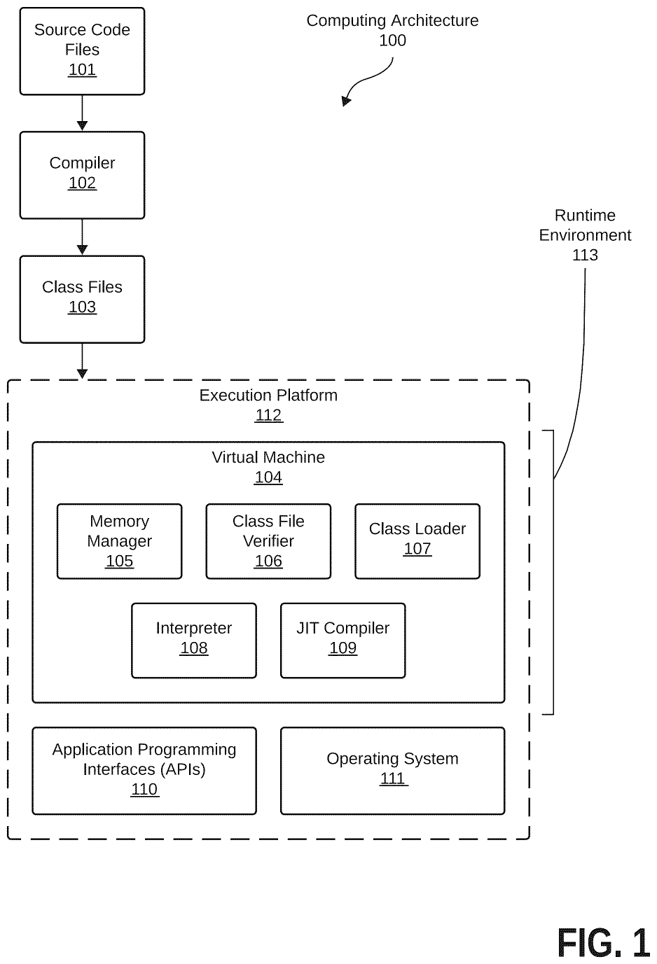

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that include code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 include the virtual machine instructions that have been converted from the source code files 101. However, in other embodiments, the class files 103 may include other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may include one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class Files Structure

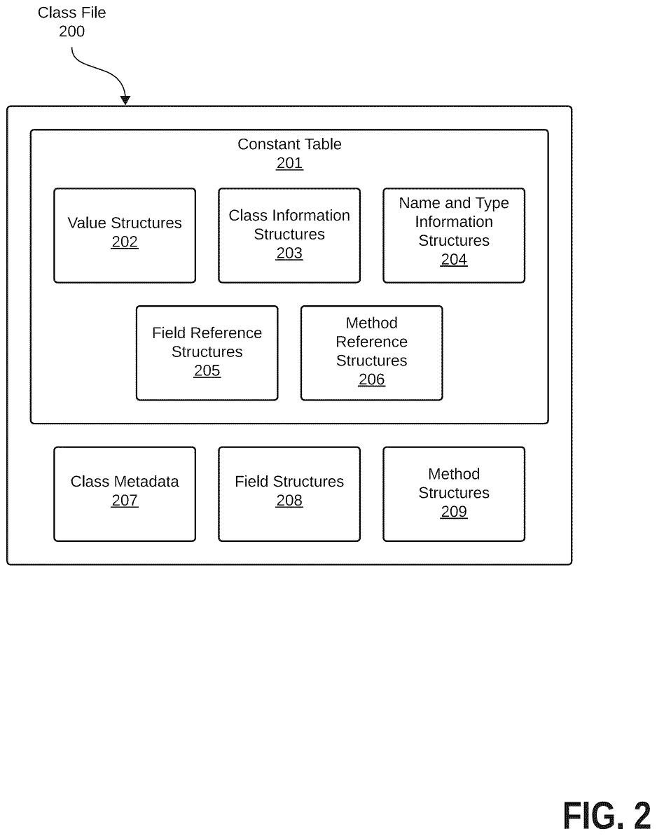

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference; thus, “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:

```
class A
{
  int add12and13( ) {
    return B.addTwo(12, 13);
  }
}
```

In the above example, the Java method add12and13 is defined in class A, takes no parameters, and returns an integer. The body of method add12 and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I) I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

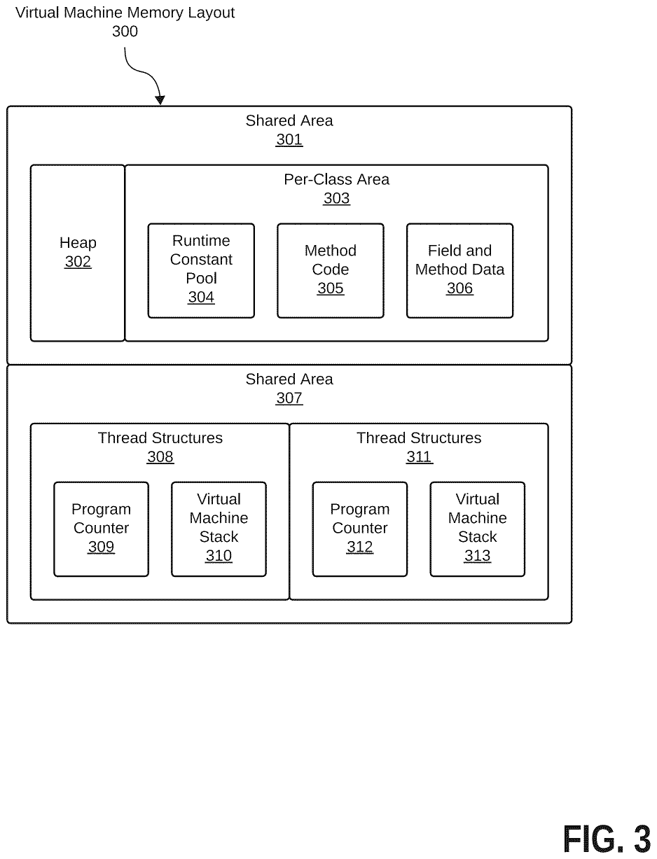

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per-class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

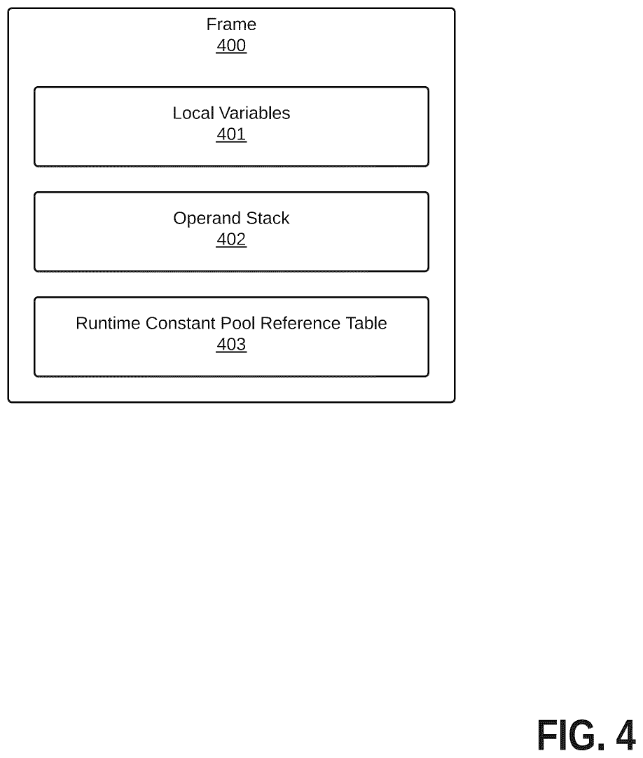

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1−N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 includes a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. CONCURRENCY MANAGEMENT SYSTEM

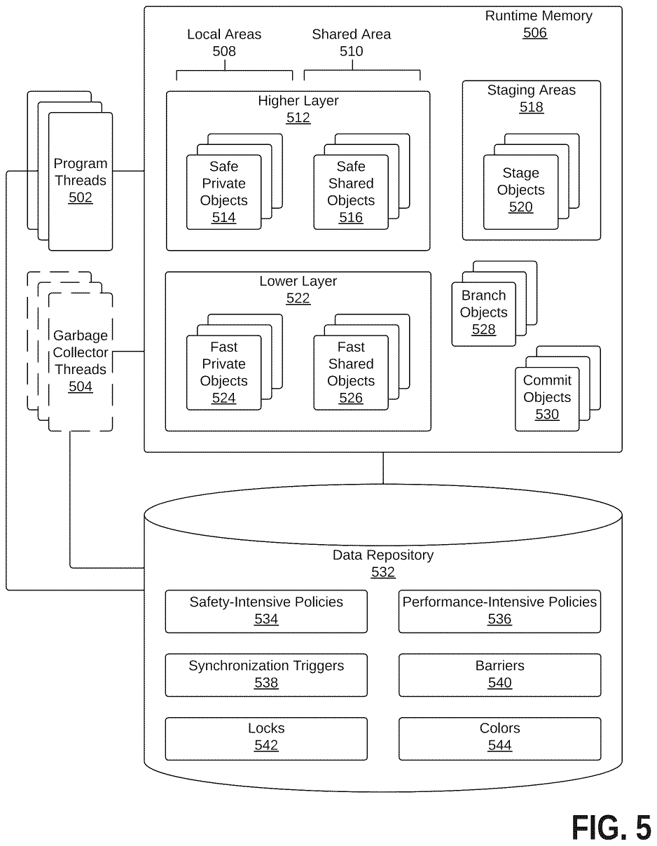

FIG. 5 illustrates a system 500 for practicing techniques described herein in accordance with one or more embodiments. As illustrated in FIG. 5, system 500 may include program threads 502, garbage collector threads 504, runtime memory 506, and data repository 532. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

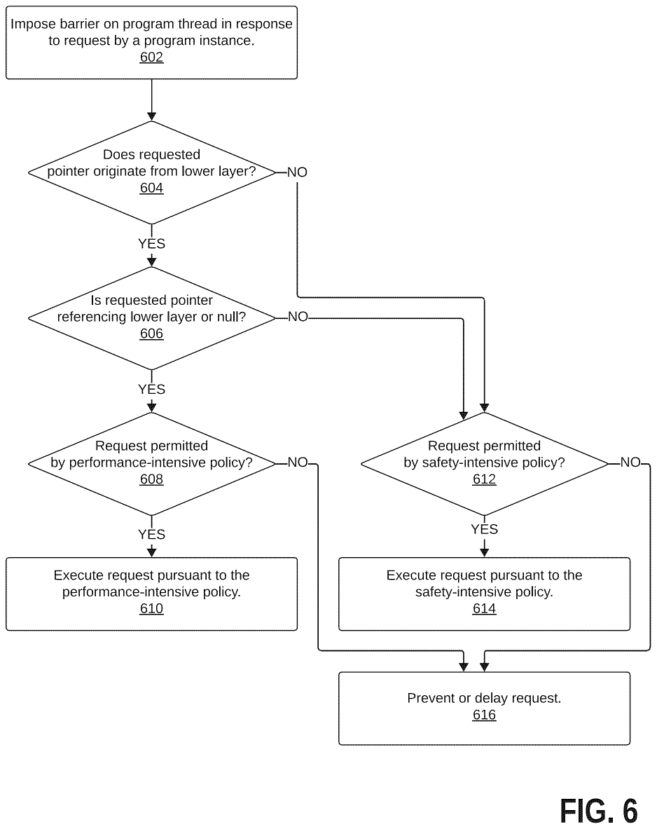

In one or more embodiments, system 500 refers to software and/or hardware configured for managing concurrent computing operations. In this way, system 500 is configured to prevent, detect, diagnose, and/or resolve concurrency issues. In particular, system 500 may be configured to manage concurrent computing operations in a multi-layered memory area. Example operations for managing concurrent computing operations in a multi-layered memory area are described below with reference to FIG. 6.

In an embodiment, system 500 is implemented in a computing environment that includes multiple threads of executions. As noted above, a thread of execution or thread, such as a program thread 502 or a garbage collector thread 504, is a subcomponent of a process. A thread may serve as an independent execution environment for executable instructions. A multi-thread computing environment is an example of a computing environment that can perform concurrent operations. A typical implementation of the Java Runtime Environment is one example of a multi-thread computing environment. The implementation of system 500 as a threaded computing environment is described herein for illustrative purposes and is not intended to define any limits to this disclosure. A threaded computing environment is neither essential nor necessary to practice the techniques described herein. The techniques described herein are equally applicable to other computing architectures. In general, the techniques described herein are applicable to any computing architecture that can perform concurrent computing operations. The techniques described herein are applicable to both centralized computing systems and distributed computing systems.

In one or more embodiments, a program thread 502 refers to a thread of execution generally allocated to perform tasks at the behest of a program instance. A task that is performed at the behest of a program instance is referred to herein as a “program task.” Note that completing some program tasks may require manipulating information residing in runtime memory 506. For instance, while completing the requests of a program instance, a program thread 502 may be creating new data structures within runtime memory 506, reading from data structures residing in runtime memory 506, writing to data structures residing in runtime memory 506, and/or performing various other operations within runtime memory 506. In addition to program tasks, a program thread 502 may be configured to perform other tasks. For example, a program thread 502 may be configured to perform concurrency management tasks, garbage collection tasks, and/or other tasks. A program thread 502 may be configured to perform tasks other than program tasks through the imposition of barriers 540.

In one or more embodiment, a garbage collector thread 504 refers to a thread of execution generally allocated to perform tasks at the behest of a garbage collection process. As used herein, the term “garbage collection” refers generally to memory management, and the term “garbage collection task” refers to a task performed at the behest of a garbage collection process. In the example context of system 500, a garbage collection process may be configured to reclaim memory allocated to data structures residing within runtime memory 506 that are no longer needed by a currently executing program instance. In some embodiments, system 500 excludes dedicated garbage collector threads 504 because garbage collection tasks are delegated to program threads 502. In other words, in some embodiments, there may be no distinction between a program thread 502 and a garbage collector thread 504. As used herein, the term “garbage collector” refers to any thread performing a garbage collection task. As noted above, both program threads 502 and garbage collector threads 504 may perform garbage collection tasks. Thus, the term “garbage collector” may refer to a program thread 502, a garbage collector thread 504, or another thread.

In one or more embodiments, runtime memory 506 refers to a data repository that includes memory space allocated for the use of at least one program instance during runtime. For example, runtime memory 506 may include data structures, such as shared data structures and private data structures, generated by program threads 502 during program execution. In addition to including information that can be manipulated by a program thread 502 at the behest of a program instance, runtime memory 506 may include information that is not exposed at a program level. For example, runtime memory 506 may include data structures and/or references to data structures that cannot be accessed by a program thread 502 while that program thread 502 is actively executing executable instructions for a program instance. Note that in this example, these data structures that are not exposed at a program level may be accessible to the program thread 502 if and when the program thread 502 is not actively performing program tasks. For instance, in this example, data structures that are generally inaccessible to a program thread 502 while actively performing program tasks may be accessible to the program thread 502 while actively performing concurrency management tasks and/or garbage collection tasks. As illustrated in FIG. 5, runtime memory 506 may be organized into various areas, such as local areas 508, a shared area 510, staging areas 518, and/or other areas. Additionally, or alternatively, runtime memory 506 may be organized into generations and/or other logical or physical subdivisions. For example, runtime memory 506 may be organized into a young generation and an old generation. Runtime memory 506 may be implemented on any type of storage unit and/or device (e.g., a file system, database, collection of tables, or any other storage mechanism) for storing data. Furthermore, runtime memory 506 may be implemented on multiple different storage units and/or devices. The multiple different storage units and/or devices may or may not be of the same type or located at the same physical site. Runtime memory 506 may be implemented in volatile memory, and/or runtime memory 506 may be implemented in persistent memory.

In an embodiment, runtime memory 506 is implemented in the context of one or more class-based, object-oriented programming languages. Examples of class-based, object-oriented programming languages include Java, C++, C#, Python, Ruby, and others. The implementation of runtime memory 506 in the context of class-based, object-oriented program language(s) is described herein for illustrative purposes and is not intended to define any limits to the present disclosure. A class-based, object-oriented programming language is neither essential nor necessary to practice the techniques described herein. The techniques described herein are equally applicable to other data structures, other computing environments, and other programming languages.

In an embodiment, information is represented within runtime memory 506 by runtime objects. A runtime object is a data structure that exists in memory during program execution (i.e., runtime). A runtime object may be conceptualized as a higher-level abstraction of binary data that resides somewhere in low-level memory. For example, a runtime object may be an abstraction of binary data stored to main memory (e.g., random access memory (RAM)) or a cache (e.g., a thread-local cache). In the example that is illustrated by FIG. 3, runtime memory 506 may be implemented, in whole or in part, within heap 302. Example runtime objects include class instances, arrays, and other data structures. A runtime object within runtime memory 506 may be a shared object, a private object, a staged copy of another runtime, or another variety of runtime object. As illustrated in FIG. 5, runtime memory 506 may include safe private objects 514, safe shared objects 516, stage objects 520, fast private objects 524, fast shared objects 526, and/or other types of runtime objects.

In an embodiment, a runtime object in runtime memory 506 may include direct-write field(s) and/or non-direct-write field(s). As noted above, the term “direct-write field” refers to a field whose value is generally (a) written directly to main memory and (b) read directly from main memory. For example, if a value is written to a direct-write field, a thread will generally not be permitted to delay storing that value in main memory in favor of performing some other program task. In comparison, if a value is written to a non-direct-write field, a thread may delay storing that value in main memory, and that value may reside in a cache, such as a thread-local cache, while storage of this value to main memory is being delayed. While a value stored to a direct-write field is generally not permitted to languish in a cache while storage to main memory is postponed, note that a value that is written to a direct-write field may temporarily reside in a cache during the process of storing that value to main memory. For example, a value written to a direct-write field may be temporarily stored in a cache to preserve visibility guarantees while that value is being stored to main memory. In general, the implementation of direct-write fields may vary between embodiments. For example, with respect to Java, a direct-write field may be implemented using the “volatile” keyword; in contrast, with respect to C or C++, a direct-write field may be implemented using the “std::atomic” tokens.

In an embodiment, runtime memory 506 is subject to at least one garbage collection process during runtime. For example, during runtime, a garbage collection process may be configured to reclaim memory space allocated to runtime objects residing in runtime memory 506. In this example, the garbage collection process may classify memory space allocated to a runtime object as being eligible for reclamation if that runtime object has become less than strongly reachable. A runtime object is generally considered strongly reachable if there is at least one chain of strong reference(s) that can be traversed by at least one program thread 502 to access that runtime object at the behest of a program instance. The term “strong reference” refers to a reference that (a) fully participates in a reachability analysis performed by a garbage collector and (b) is not subjected to the collection rules that are applied to specialized references, such as soft references, weak references, phantom references, and so on. If there is no chain of strong reference(s) that can be traversed by a program thread 502 to access a runtime object at the behest of a program instance, that runtime object will generally not be considered strongly reachable. Note that a runtime object being less than strongly reachable to a program thread 502 does not necessarily imply that the runtime object is unreachable to that program thread 502. For example, a runtime object that is not strongly reachable may remain reachable through a non-strong reference. Furthermore, the term “unreachable” is not necessarily synonymous with the term “inaccessible.” For example, a runtime object that is unreachable to a program thread 502 may remain accessible to a garbage collector thread 504. As used herein, the term “disposable” identifies information eligible for garbage collection, and the term “live” identifies information ineligible for garbage collection. While strongly reachable objects are generally live objects, note that the term “live” is not interchangeable with “strongly reachable.” For example, runtime objects that are less than strongly reachable, such as softly reachable objects, may be live objects in at least some cases. In other embodiments, runtime memory 506 is not subjected to a separate garbage collection process during runtime. For example, in these other embodiments, disposable information may be deallocated by threads while executing the executable instructions of a program instance.

In one or more embodiments, a local area 508 refers to a section of runtime memory 506 that is generally allocated for the private objects of a specific program thread 502. There may be a local area 508 in runtime memory 506 for any given program thread 502. As used herein, the term “private object” refers to a runtime object that (a) a program instance can interact with through a single program thread and (b) is not a staged copy of another runtime object. If a runtime object is a private object, there is a single program thread 502 that can access that runtime object at the behest of a program instance; no other program thread 502 can obtain a traversable reference to that runtime object while performing a program task. As noted above, some forms of “reachability” do not coincide with accessibility. Thus, a runtime object that is reachable to multiple program threads 502 may nonetheless be a private object. Note that the use of the word “private” as an adjective in the term “private object” does not refer to a private accessor flag. A private object does not necessarily include a private field. In many cases, a private object includes no private fields. Generally, a runtime object is initially a private object when that runtime object is instantiated; after being instantiated, a private object may become a shared object. As illustrated in FIG. 5, a local area 508 may include safe private objects 514, fast private objects 524, and/or other types of private objects.

In one or more embodiments, a shared area 510 refers to a section of runtime memory 506 that is generally allocated for storing shared objects. As used herein, the term “shared object” refers to runtime object that is accessible to a program instance through multiple program threads 502. Generally, a program instance is able to interact with a runtime object through a program thread 502 if there is at least one chain of references leading to the runtime object that can be traversed by the program thread 502 while executing the program instance. Note that some references, such as phantom references, cannot be traversed by a program thread 502 while executing a program instance. As noted above, multiple conflicting accesses to a shared object may give rise to a concurrency issue. For example, two accesses to a shared object conflict if (a) those two accesses are performed in furtherance of two separate tasks being performed concurrently and (b) at least one of those tasks is attempting to mutate the shared object. If the two conflicting accesses are allowed to occur in this example, a data race may occur. However, note that conflicting accesses do not necessarily result in a data race or another concurrency issue. It should also be noted that, in some cases, two accesses to a shared object may conflict even if both of those two accesses are reading from the shared object and not mutating the shared object. As illustrated in FIG. 5, a shared area 510 may include safe shared objects 516, fast shared objects 526, and/or other types of shared objects.

In one or more embodiments, a higher layer 512 refers to a section of runtime memory 506 that is allocated for safe objects. A higher layer 512 may be a logical subdivision of runtime memory and/or a physical subdivision of runtime memory. If a higher layer 512 is a physical subdivision of runtime memory, that physical subdivision may or may not be contiguous. As used herein, the term “safe object” refers to a runtime object that may be subject to at least one concurrency management policy configured to prioritize concurrency safety over program performance, at least in some respects, and the term “concurrency management policy” refers to information describing rule(s) for managing a computing environment capable of concurrency. As illustrated in FIG. 5, a higher layer 512 of runtime memory 506 may include safe private objects 514 and safe shared objects 516. In one or more embodiments, a safe private object 514 refers to a runtime object that is both a safe object and a private object, and a safe shared object 516 refers to a runtime object that is both a safe object and a shared object.

In one or more embodiments, a staging area 518 refers to a section of runtime memory 506 allocated for a staged copy of a data set. As used herein, a “staged” copy of a data set refers to a copy of the data set that is created for staging the execution of a task that is attempting to access this data set. As used herein with respect to a task that is attempting to access a data set, “staging” the execution of this task refers to redirecting the execution of this task to operate on a staged copy of this data set instead of the operating on the data set. As an example, consider a request that is attempting to write a value to a field of a shared object. In this example, staging the execution of this request might entail (a) creating a staged copy of the shared object in a staging area 518 and/or (b) writing the value to the corresponding field in the staged copy of the shared object. A staged copy of a data structure that is included in a staging area 518 may be accessible to no program threads 502, a single program thread 502, or multiple program threads 502. As illustrated in FIG. 5, staging areas 518 may include stage objects 520. Additionally, or alternatively, staging areas 518 may include staged copies of other data structures.

In an embodiment, a staging area 518 is exposed to a subset of the program threads 502 that share access to runtime memory 506. In an example, a staging area 518 is exposed to a single program thread 502, and other program threads 502 are unable to access information residing in this staging area 518 while performing program tasks. In other words, this staging area 518 is isolated from the other program threads 502 in this example.

In an embodiment, a staging area 518 is configured to serve as an isolated section of runtime memory 506 where a program thread 502 is permitted to access shared, non-volatile information. For example, within a staging area 518, a program thread 502 may be permitted to read from and/or write to non-direct-write fields of runtime objects that are instantiated in the staging area 518. In this embodiment, a program thread 502 may be prevented from directly accessing shared, non-volatile information that resides outside of a staging area 518.

In an embodiment, multiple staging areas 518 are allocated for a single program thread 502. The multiple staging areas 518 may correspond to a different staged copies of a data set. A staging area 518 that includes the most recent staged copy of a data set that is accessible to a program thread 502 may be referred to herein as this program thread's 502 “current staging area,” and a program thread 502 may be referred to herein as being “based” in the program thread's 502 current staging area.

In one or more embodiments, a stage object 520 refers to a staged copy of a runtime object. A stage object 520 may be a staged copy of a safe private object 514, a safe shared object 516, a fast private object 524, a fast shared object 526, and/or other types of runtime objects. A staged copy of a runtime object (i.e., a stage object 520) may include values that are copied from the runtime object, other staged copies of the runtime object, and/or other memory locations. As an example, consider a stage object 520 that is a staged copy of a shared object. In this example, the stage object 520 may include values that are copied from the shared object, copies of the shared object, and/or other memory locations. As used herein with respect to a staged copy of a particular object, the term “canonical object” refers to the particular object. For example, if a stage object 520 is a staged copy of a shared object, then this shared object is the stage object's 518 corresponding canonical object. Similarly, with respect to a staged copy of a particular data structure, the term “canonical data structure” refers here to the particular data structure. As used herein, the term “canonical data set” refers to a copy of a data set that includes at least one canonical data structure. Note that the state of one staged copy of a runtime object may differ from the state of another staged copy of this same runtime object. Furthermore, the state of a stage object 520 may differ from the state of the corresponding canonical object. It should also be noted that in the instant after the state of a canonical object is updated to match the state of a corresponding stage object 520, the precise state of the canonical object may still differ from the state of the corresponding stage object 520. For example, a direct-write field in a stage object 520 may be configured differently than the same direct-write field in a corresponding canonical object even in the instant after the state of the canonical object is updated to match the state of the stage object 520.

In one or more embodiments, a lower layer 522 refers to a section of runtime memory 506 that is generally allocated for fast objects. A lower layer 522 of runtime memory 506 may be a logical subdivision of runtime memory 506 and/or a physical subdivision of runtime memory 506. If a lower layer 522 is a physical subdivision of runtime memory 506, that physical subdivision may or may not be contiguous. As used herein, the term “fast object” refers to a runtime object that may be subject to at least one concurrency management policy configured to prioritize program performance over concurrency safety, at least in some respects. As illustrated in FIG. 5, a lower layer 522 of runtime memory 506 may include fast private objects 524, fast shared objects 526, and/or other types of fast objects. In one or more embodiments, a fast private object 524 refers to a runtime object that is both a fast object and a private object, a fast shared object 526 refers to a runtime object that is both a fast object and a shared object.

In one or more embodiments, a branch object 528 refers to a runtime object used to track the current version of a data set. For instance, a branch object 528 may track the current version of a set of runtime object(s). As an example, consider a stage object 520 that includes a direct-write field. In this example, the direct-write field in the stage object 520 includes a reference to a branch object 528 used to track the current version of a shared object that corresponds to the stage object 520. The branch object 528 of this example includes a current commit field, and the current commit field holds another reference to a commit object 530 that represents the current version of the shared object. In this example, a thread may discern the current version of the shared object by traversing (a) the reference from the stage object 520 to the branch object 528 and (b) the other reference from the branch object 528 to the commit object 530. There may be multiple stage objects 520 corresponding to the shared object in this example, and the multiple stage objects 520 may refer to the same branch object 528.

In one or more embodiments, a commit object 530 refers to a runtime object that represents a version of a data set. For instance, a commit object 530 may represent a version of a set of runtime object(s). An example commit object 530 may record an identifier of a version of a set of runtime objects represented by the commit object 530, values held by direct-write fields in this version of the set of runtime objects, mutations that derived this version of the set of runtime objects from a prior version of the set of runtime objects, and/or other information. Furthermore, the example commit object 530 may refer to other commit objects 530. For instance, the example commit object 530 may include a field that refers to another commit object 530 that represents the prior version of the set of runtime objects.

In one or more embodiments, a data repository 532 is any type of storage unit and/or device (e.g., a file system, database, collection of tables, or any other storage mechanism) for storing data. Furthermore, a data repository 532 may include multiple different storage units and/or devices. The multiple different storage units and/or devices may or may not be of the same type or located at the same physical site. Furthermore, a data repository 532 may be implemented or executed on the same computing system as other components of system 500. Additionally, or alternatively, a data repository 532 may be implemented or executed on a computing system separate from other components of system 500. A data repository 532 may be communicatively coupled to other components of system 500 via a direct connection or via a network. As illustrated by FIG. 5, a data repository 532 may include information describing a safety-intensive policies 534, a performance-intensive policies 536, synchronization triggers 538, barriers 540, locks 542, and colors 544. Information describing safety-intensive policies 534, a performance-intensive policies 536, synchronization triggers 538, barriers 540, locks 542, and colors 544 may be implemented across any of the components within system 500. However, this information is illustrated within a data repository 532 for purposes of clarity and explanation.

In one or more embodiments, a safety-intensive policy 534 refers to a concurrency management policy configured to prioritize concurrency safety over program performance, at least in some respects. As noted above, a concurrency management policy is information describing rule(s) for managing a computing environment that is capable of concurrency. Safety-intensive policies 534 are generally applicable to requests that involve higher-layer addresses. As used herein, the term “higher-layer address” refers to a memory address corresponding to a higher layer 512 of runtime memory 506, and the term “lower-layer address” refers to a memory address corresponding to a lower layer 522 of runtime memory 506. For example, a safety-intensive policy 534 may be applicable to a request that is attempting to read from or write to a safe private object 514 or a safe shared object 516. Safety-intensive policies 534 may define (a) criteria for permissible requests, (b) procedures for executing permissible requests, and/or (c) other rules for managing computing environments that are capable of concurrency. Safety-intensive policies 534 may specify various concurrency-management mechanism that should be applied for concurrency safety. On aggregate, safety-intensive policies 534 specify for more extensive and/or rigorous application of concurrency-management mechanisms than performance-intensive policies 536, at least in some respects. Example concurrency-safety mechanisms that safety-intensive policies 534 may specify for application include concurrency checks, version controls, staging areas, memory transactions, synchronization procedures, memory fencing, locks, atomic operations, memory-visibility mechanisms, and other concurrency-safety mechanisms.

In an embodiment, a safety-intensive policy 534 prohibits a program instance from directly interacting certain data structures. For example, a safety-intensive policy 534 may prohibit a program thread 502 from directly interacting with safe shared objects 514 while actively executing a program task. Rather than directly interacting with certain data structures, the safety-intensive policy 534 of this embodiment may specify that a program thread 502 interacts with these data structures indirectly. Example safety-concurrency mechanisms that can be used to indirectly interact with a data structure include software memory transactions, version management, staging the execution of tasks, and others.

In an embodiment, a safety-intensive policy 534 calls for staging the execution of certain tasks. For example, a safety-intensive policy 534 may call for staging the execution of a task that reads from and/or writes to a safe shared object 516. In another example, a safety-intensive policy 534 calls for staging the execution of a task that loads or stores a pointer that references a higher-layer address. As noted above, a pointer is a set of bits that is at least partially allocated for storing a memory address. A pointer may be “partially” allocated for storing a memory address because the pointer may include more bits than are needed to address a location in memory. The address bits of a pointer are the bits in this pointer that are actually utilized for storing a memory address. As used herein, a pointer “refers to” or “references” the memory address that is encoded into the address bits of the pointer and the layer of runtime memory 506 corresponding to this memory address.

In an embodiment, a safety-intensive policy 534 calls for performing concurrency checks before, while, and/or after executing certain tasks. As noted above, a concurrency check is a check for potential concurrency issues and/or causality bugs. Example concurrency-safety mechanisms that may be utilized to perform a concurrency check mandated by a safety-intensive policy 534 include an object graph of commit objects 530, event tracing, execution tracing, Lamport timestamps, vector clocks, hybrid logical clocks, timestamps, read/write counters, locks 542, data-flow analysis, and others.

In an embodiment, a safety-intensive policy 534 calls for version management procedures to be applied to certain tasks. For example, a safety-intensive policy 534 may call for the creation and maintenance of commit objects 530 to track (a) a version history of canonical objects and (b) a version history of the corresponding stage objects. Note that, in this example, the respective version histories that are recorded via the commit objects 530 may serve as a means for facilitating concurrency checks and synchronization procedures that may also be specified by the safety-intensive policy 534.

In an embodiment, a safety-intensive policy 534 is applicable to a request that attempts to load or store a pointer that originates from a higher-layer address. With respect to a request attempting to load a pointer, the pointer's “origin” refers herein to the memory address where the request is attempting to load the pointer from and the layer of runtime memory 506 corresponding to this memory address. For example, if a request is attempting to load a pointer held by a field of a runtime object, then pointer's origin is the memory address of this object field. With respect to a request attempting to store a pointer, the pointer's origin refers herein to the memory address where the request is attempting to store the pointer and the layer of runtime memory 506 corresponding to this memory address. For example, if a request is attempting to store a pointer to an element of an array, then the pointer's origin is the memory address of that array element.

In an embodiment, a safety-intensive policy 534 is applicable to a request that attempts to load or store a pointer that refers to a higher-layer address. With respect to a request that is attempting to load or store a pointer, the pointer “refers to” or “references” the memory address that is encoded into the address bits of the pointer and the layer of runtime memory 506 corresponding to this memory address. If a pointer does not refer to any data structure in runtime memory, then the pointer is null. A pointer may be set to null by encoding a specific value representing the absence of any referent into the address bits of the pointer.

In an embodiment, a safety-intensive policy 534 is applicable to a request that attempts to load or store a pointer that (a) originates from a lower-layer address and (b) references a higher-layer address. For example, this safety-intensive policy 536 is applicable to a request attempting to load or store a pointer that (a) originates from a fast object and (b) references a safe object. As used herein, the term “fast-to-safe pointer” refers to a pointer that (a) originates from a lower-layer address and (b) references a higher-layer address.

In an embodiment, a safety-intensive policy 534 is applicable to a request that attempts to load or store a pointer that (a) originates from a higher-layer address and (b) references a lower-layer address. For example, this safety-intensive policy 536 is applicable to a request attempting to load or store a pointer that (a) originates from a safe object and (b) references a fast object. As used herein, the term “safe-to-fast pointer” refers to a pointer that (a) originates from a higher-layer address and (b) references a lower-layer address.

In an embodiment, a safety-intensive policy 534 is applicable to a request that attempts to load or store a pointer that (a) originates from a higher-layer address and (b) references a higher-layer address. For example, this safety-intensive policy 534 is applicable to a request attempting to load or store a pointer that (a) originates from a safe object and (b) references a safe object. As used herein, the term “safe-to-safe pointer” refers to a pointer that (a) originates from a higher-layer address and (b) references a higher-layer address.

In an embodiment, a safety-intensive policy 534 is applicable to a request that attempts to load or store a pointer that (a) originates from a higher-layer address and (b) is null. For example, this safety-intensive policy 534 is applicable to a request attempting to load or store a pointer that (a) originates from a safe object and (b) is null. As used herein, the term “safe-to-null pointer” refers to a pointer that (a) originates from a higher-layer address and (b) is null.

In an embodiment, a safety-intensive policy 534 prohibits loading or storing a pointer to a non-direct-write field if that pointer (a) originates from one layer of runtime memory 506 and (b) references another layer of runtime memory 506. As used herein, the term “inter-layer pointer” refers to a pointer that (a) originates from one layer of runtime memory 506 and (b) references another layer of runtime memory 506. A safe-to-fast pointer and a fast-to-safe pointer are examples of inter-layer pointers. A safety-intensive policy 534 of this embodiment may permit loading an inter-layer pointer from or storing an inter-layer pointer to a direct-write field. Furthermore, a safety-intensive policy 534 of this embodiment may permit intra-layer pointers to be loaded from and stored to direct-write fields and non-direct write fields. As used herein, the term “intra-layer pointer” refers to a pointer that (a) originates from one layer of runtime memory 506 and (b) does not refer to another layer of runtime memory 506. A safe-to-safe pointer and a safe-to-null pointer are examples of intra-layer pointers.

In an embodiment, a safety-intensive policy 534 prohibits storing a fast-to-safe pointer in a lower-layer address, at least in some cases. As an example, consider a request that is attempting to store a pointer to a field of a fast object. If the pointer of this example refers to a safe object, then the safety-intensive policy 534 of this embodiment may prohibit the request. A safety-intensive policy 534 may be configured to prohibit storing a fast-to-safe pointer in a lower-layer address because doing might allow one program thread 502 to gain access to the local area 508 of another program thread 502.

In one or more embodiments, a performance-intensive policy 536 refers to a concurrency management policy configured to prioritize program performance over concurrency safety, at least in some respects. As noted above, a concurrency management policy is information describing rule(s) for managing a computing environment that is capable of concurrency. Performance-intensive policies 536 are generally applicable to requests that access lower-layer addresses. For example, a performance-intensive policy 536 may be applicable to a request that is attempting to read from or write to a fast private object 524 or a fast shared object 526. Performance-intensive policies 536 may define (a) criteria for permissible requests, (b) procedures for executing permissible requests, and/or (c) other rules for managing computing environments that are capable of concurrency. Performance-intensive policies 536 may specify various concurrency-management mechanism that should be applied for concurrency performance. On aggregate, performance-intensive policies 536 specify for less extensive and/or rigorous application of concurrency-management mechanisms than safety-intensive policies 534, at least in some respects. Example concurrency-safety mechanisms that performance-intensive policies 536 may specify for application include concurrency checks, version controls, staging areas, memory transactions, synchronization procedures, memory fencing, locks, atomic operations, memory-visibility mechanisms, and other concurrency-performance mechanisms.

In an embodiment, a performance-intensive policy 536 permits a program instance to directly interact with certain data structures. For example, while a program thread 502 is executing a program task, a performance-intensive policy 536 may permit the program thread 502 to (a) read primitive values directly from fast private objects 524 and fast shared objects 526 and/or (b) write primitive values directly to fast private objects 524 and fast shared objects 526. Furthermore, while the program thread 502 is executing the program task in this example, the performance-intensive policy 536 may permit the program thread 502 to (a) load an intra-layer pointer from a lower-layer address and/or (b) store an intra-layer pointer to a lower-layer address.

In an embodiment, a performance-intensive policy 536 specifies that a program thread 502 should execute memory fences while interacting with certain data structures. For example, if a program is attempting to access a shared object, and if a safety-intensive policy 534 is not applicable to this request, then a performance-intensive policy 535 may stipulate that a program thread 502 should execute memory fencing while performing the request. Example memory fences that may be specified in a performance-intensive policy 536 and/or another concurrency policy include a load fence, a store fence, an acquire fence, a release fence, a read-write fence, and others.

In an embodiment, a performance-intensive policy 536 is applicable to a request that attempts to load or store a pointer that (a) originates from a lower-layer address and (b) references a lower-layer address. For example, this performance-intensive policy 536 is applicable to a request attempting to load or store a pointer that (a) originates from a fast object and (b) references a fast object. As used herein, the term “fast-to-fast pointer” refers to a pointer that (a) originates from a lower-layer address and (b) references a lower-layer address. A fast-to-fast pointer is an example of an intra-layer pointer.

In an embodiment, a performance-intensive policy 536 is applicable to a request that attempts to load or store a pointer that (a) originates from a lower-layer address and (b) is null. For example, this performance-intensive policy 536 is applicable to a request attempting to load or store a pointer that (a) originates from a fast object and (b) is null. As used herein, the term “fast-to-null pointer” refers to a pointer that (a) originates from a lower-layer address and (b) is null. A fast-to-null pointer is an example of an intra-layer pointer.

In one or more embodiments, a synchronization trigger 538 refers to an event, condition, and/or other stimuli that triggers a synchronization process. For instance, a synchronization trigger 538 may precipitate an attempt to synchronize divergent mutations applied to separate copies of a data set. In general, the events, conditions, and/or stimuli that will amount to synchronization triggers 538 may vary between embodiments. Example events, conditions, and/or other stimuli that may be synchronization triggers 538 include an attempt to access a direct-write field, an attempt to access a final field, a program task that is defined using a synchronized keyword, a program task that is defined using an atomic keyword, a program task that involves accessing a memory location through a var handle, a joining of threads, a termination of a thread, a garbage collection task that requires synchronization of runtime memory, and others.

In an embodiment, a synchronization trigger 538 causes an attempt to synchronize (a) any mutations that have been applied to a canonical data set with (b) any mutations that have been applied to at least one staged copy of the data set. For example, a synchronization trigger 538 may initiate an attempt to synchronize (a) any mutations that have been applied to a set of shared objects with (b) any mutations that have been applied to staged copies of these shared objects (i.e., stage objects 520).

In an embodiment, a synchronization trigger 538 is explicitly represented in the executable instructions of a program instance. For example, a synchronization trigger 538 may be a request by a program instance for performance of a program task by a program thread 502.

In an embodiment, a synchronization trigger 538 is an attempt to access a direct-write field. For example, a synchronization trigger 538 may be a request by a program instance for performance of a program task that involves reading from and/or writing to a direct-write field of a runtime object.

In an embodiment, a synchronization trigger 538 is a request from a program instance for performance of a program task that is defined in source code with a specific token. Example tokens that may be configured to trigger a synchronization process include a synchronized keyword, an atomic keyword, and others. In general, the tokens that are configured to trigger synchronization processes may vary between embodiments.

In an embodiment, a synchronization trigger 538 is a request by a program instance for performance of a program task that involves accessing a memory location using an access mechanism associated with memory ordering semantics. For example, a synchronization trigger 538 may be a request by a program instance for performance of a program task that involves accessing a memory location using a var handle.

In an embodiment, a synchronization trigger 538 is not explicitly represented in the executable instructions of a program instance. For example, a synchronization trigger 538 may be a termination of a thread, a joining of threads, an attempt by a garbage collection process to synchronize threads during a garbage collection cycle, or some other occurrence that is not necessarily explicitly represented within the executable instructions of the program instance.

In one or more embodiments, a barrier 540 refers to an additional set of executable instructions inserted into, or proximate to, executable instructions for completing a task. For example, while converting class files 103 of a program into machine-level code, JIT compiler 109 may insert barriers 540 into the machine-level instructions that correspond to the program tasks to be performed by a program thread 502. A barrier 540 is referred to herein as being “imposed” on a thread when the thread is actively performing the executable instructions defined in the barrier 540. Barriers 540 may be imposed on program threads 502, and/or barriers 540 may be imposed on garbage collector threads 504. By imposing a barrier 540 on a program thread 502 that is completing requests of a program instance, system 500 may direct the program thread 502 to perform tasks other than program tasks. Example barriers 540 that may be imposed on a thread include load barriers, store barriers, and others.

In an embodiment, a barrier 540 is a load barrier. As used herein, the term “load barrier” refers to a barrier 540 imposed on a thread in response to the thread being instructed to perform a load operation. An example load operation is a request by a program instance for a program thread 502 to load a pointer that refers to a runtime object. An example load barrier defines operations that a program thread 502 should perform before and/or after a load operation that triggers the imposition of the example load barrier.

In an embodiment, a barrier 540 is a store barrier. As used herein, the term “store barrier” refers to a barrier 540 imposed on a thread in response to the thread being instructed to perform a store operation. An example store operation is a request by a program instance for a program thread 502 to write a value to a location in memory such as an object field of a runtime object. An example store barrier defines operations that a program thread 502 should perform before and/or after a store operation.

In an embodiment, a barrier 540 includes executable instructions for determining what concurrency management policy(s) are applicable to a request. A barrier may be configured to determine what concurrency policy is applicable to a request based on pointer coloring, executable instructions of a program instance, and/or other inputs.

In an embodiment, a barrier 540 includes executable instructions for enforcing concurrency management policy(s). For example, a barrier 540 may be configured to enforce a safety-intensive policy 534, a performance-intensive policy 536, and/or other concurrency management policies. In general, the operations require to enforce a concurrency management policy may vary between embodiments. An example barrier 540 for enforcing a concurrency management policy may define logic for staging the execution of tasks, synchronizing divergent mutations to copies of a data set, performing concurrency checks, failure handling, remapping pointers, defining new colors, coloring pointers, creating and maintaining commit objects, rebasing threads, and various other operations.

In an embodiment, different barriers 540 are respectively configured for enforcing a different concurrency management policies, and the system 500 determines if and what concurrency management policy is applicable to a program instance's request prior when determining if and what barrier 540 should be inserted into the executable instructions of the program instance in response to this request.

In an embodiment, a barrier 540 includes executable instructions for synchronizing divergent mutations to copies of a data set. For example, during a synchronization process, a barrier 540 may instruct a thread to create a new staged copy of a data set by synchronizing (a) any mutations that have been applied to the canonical data set with (b) any mutations that have been applied to a preexisting staged copy of the canonical dataset.

In an embodiment, a barrier 540 includes executable instructions for coloring a pointer to indicate the layer of runtime memory 506 that is referenced by the pointer. For example, a barrier 540 may include executable instructions for encoding one color 544 into pointers that refer to one layer of runtime memory 506, and/or the barrier 540 may include executable instructions for encoding another color 544 or no color into pointer that refer to another layer of runtime memory 506.

In an embodiment, a barrier 540 includes executable instructions for performing a concurrency check. As noted above, a concurrency check is a check for potential concurrency issues and/or causality bugs. Example mechanisms that may be leveraged by a barrier 540 to perform a concurrency check include object graphs, event tracing, execution tracing, Lamport timestamps, vector clocks, hybrid logical clocks, timestamps, read/write counters, locks 542, data-flow analysis, and others.

In an embodiment, a barrier 540 includes executable instructions for detecting conflicting mutations to separate copies of a data set (i.e., a concurrency check). For example, during a synchronization process, a barrier 540 may instruct a thread to determine if any mutations that have been applied to a canonical object conflict with any mutations that have been applied to a stage object 520. As used herein, the term “canonized mutation” refers to a mutation applied to a canonical data structure, and the term “staged mutation” refers to mutation applied to a staged copy of a canonical data structure.

In an embodiment, a barrier 540 includes executable instructions for failure handling. For example, if a concurrency check performed during a synchronization process reveals a conflict between a canonized mutation and a staged mutation, a barrier 540 may direct a thread to (a) abort the synchronization process, (b) restart the program task that triggered the synchronization process, (c) flag the conflict to a user as a manifestation of a causality bug, (d) terminate a program instance, and/or (e) perform other corrective actions.

In an embodiment, a barrier 540 includes executable instructions for rebasing a program thread 502. As used herein, the term “rebasing” refers to (a) allocating a new staging area 518 for a program thread 502 and/or (b) creating a new staged copy of a data set in the new staging area 518. In an example, a barrier 540 instructs a program thread 502 to rebase itself during a synchronization process. In another example, a barrier 540 instructs a program thread 502 to rebase itself while restarting a program task after a concurrency check revealed a conflict mutation resulting from a previous attempt to complete this program task.

In an embodiment, a barrier 540 include executable instructions for remapping a pointer. As noted above, a pointer is a set of bits that is at least partially allocated for storing an address of a memory location. As noted above, the address bits of a pointer are the bit(s) of the pointer that are allocated for storing an address of a memory location. Note that pointer may include more bits than are needed to store an address of a memory location. In general, a pointer may be remapped by updating the address bits of the pointer. In an example, a barrier 540 includes executable instructions for remapping a pointer that refers to an unsynchronized stage object so that this pointer instead refers to a synchronized stage object.

In an embodiment, a barrier 540 includes executable instructions for consulting a forwarding table. As used herein, the term “forwarding table” refers to mapping(s) between copies of a data structure. For instance, a forwarding table may map a synchronized stage object to an unsynchronized stage object and/or a canonical object. In an example, a barrier 540 directs a thread to consult a forwarding table to determine if a pointer that refers to a stage object 520 requires remapping.

In an embodiment, a barrier 540 includes executable instructions for updating a forwarding table. For example, after a synchronized stage object has been created, a barrier 540 may direct a thread to update a forwarding table to include an entry mapping the synchronized stage object to an unsynchronized stage object and/or a canonical object.

In an embodiment, a barrier 540 includes executable instructions for coloring a pointer. In other words, a barrier 540 may include executable instructions for embedding metadata into bits within a pointer that are not being utilized to store an address of a memory location. As used herein, the term “non-address bits” refers to bit(s) of a pointer that are not being utilized to store an address of a memory location. In an example, a barrier 540 includes executable instructions for storing a color 544 into the non-address bits of a pointer and/or stripping a color 544 from the non-address bits of a pointer.

In an embodiment, a barrier 540 includes executable instructions for performing garbage collection tasks. A barrier 540 may include executable instructions for performing garbage collection tasks directed to private objects, shared objects, stage objects, safe objects, fast objects, and/or other types of data structures.

In one or more embodiments, a lock 542 refers to a mechanism for controlling access to a memory location. For example, a lock 542 may be used to restrict access to a shared object. If a thread holds a lock 542 on a shared object, other threads may be prevented from manipulating that shared object if the thread retains the lock 542 on the shared object. Example locks 542 that may be utilized to restrict access to a memory location include mutex locks, read-write locks, spinlocks, re-entrant locks, semaphore locks, and others.

In one or more embodiments, a color 544 refers to a value that is encoded into non-address bit(s) of a pointer. A color 544 may be encoded into non-address bits of a pointer to record state information associated with the pointer. For example, the coloring of a pointer may reflect the state of the pointer, the state of a data structure that is referenced by the pointer, the state of a data structure that includes the pointer, and/or state information. The state information that is described by the coloring of a pointer may be consumed by lower-level processes that facilitate program execution. For example, the state information that is recorded by the coloring of a pointer may be used to support concurrency safety, garbage collection, memory relocation, and other runtime management tasks. Note that coloring a pointer to record state information associated with the pointer may be advantageous with respect to computational efficiency because this state information can be accessed as part of reading the pointer itself, without the need for any additional load operations beyond the loading of the pointer.

In an embodiment, a color 544 is designated as indicating specific state characteristic(s) when stored to a set of non-address bit(s) within a pointer. For instance, a set of non-address bit(s) in a pointer may be allocated for describing specific state characteristic(s), and a specific color 544 may be defined to indicate the presence or absence of these specific state characteristic(s) when stored to this set of non-address bits in the pointer. In an example, a set of non-address bits in a pointer is allocated for indicating if it has been confirmed that this pointer currently refers to the correct memory location. In another example, a set of non-address bits in a pointer is allocated for indicating if a runtime object that is referenced by the pointer is reachable, and another set of non-address bits in this pointer is allocated for indicating if this runtime object is strongly reachable. As used herein, “a set of coloring bits” refers to non-address bit(s) in a pointer that are allocated for describing specific state characteristic(s). A set of coloring bits may encode a good color, a bad color, or no color. With respect to a set of coloring bits allocated for describing a state characteristic, a “good color” refers to a color 544 that can be encoded to this set of coloring bits to affirmative indicate the presence of this state characteristic, and a “bad color” refers to any color 544 other than a good color. As an example, consider a set of coloring bits in a pointer that is allocated for indicating if it has been confirmed that this pointer refers to the correct address. If this set of coloring bits include a good color in this example, then any thread that loads this pointer can assume that this pointer does in fact refer to correct memory location. However, note that the inverse is not necessarily true in this example. For instance, in this example, the presence of the bad color in this set of coloring bits does not necessarily indicate that this pointer refers to the wrong memory location. Instead, the presence of a bad color or no color in this set of coloring bits may indicate that it has not yet been confirmed that this pointer refers to the correct memory location in this example. If a set of coloring bits included in a pointer encodes a bad color or no color, then this pointer may be referred to herein as a “stale pointer.” Conversely, a pointer may be referred to as “healed” when the pointer is not stale. Note that the value that is considered a good color for one set of coloring bits may be different than the value that is considered a good color for another set of coloring bits. It should also be noted that the value considered to be the good color for a set of coloring bits may change. For example, a thread may define a new value as the good color for a set of coloring bits. When the new value is defined as the good color for the set of coloring bits in this example, the value that was previously considered to be the good color for this set of coloring bits becomes a bad color for this set of coloring bits. The current good color for a set of coloring bits in a pointer may be recorded in a memory location that is readily accessed to a thread that may encounter this pointer, and a thread may designate a new good color for this set of coloring bits by storing a new value to this memory location. In an example, the current good color for a set of coloring bits is encoded into a barrier 540, stored to a global storage mechanism, stored to a thread-local storage mechanism, and/or maintained in another memory location.

In an embodiment, a color 544 may be encoded into a pointer to indicate the layer of runtime memory 506 corresponding to the memory address that is referenced by this pointer. For instance, a pointer may include a set of coloring bits allocated for indicating if this pointer refers to the higher layer 512 of runtime memory 506, and a good color may be encoded into this set of coloring bits to affirmatively indicate that this pointer refers to the higher layer 512 of runtime memory 506. As used herein, the term “safety bits” refers to a set of coloring bits in a pointer configured to indicate if this pointer refers to the higher layer 512 of runtime memory, the term “good safety color” refers to a value that is designated as the good color for the safety bits of a pointer, and the term “bad safety color” refers to any value other than the good safety color. The good safety color may be persistent or transient. A good color is referred to herein as “persistent” is this good color is generally a constant value. For instance, a persistent good color may be a value that remains constant throughout runtime or a specific subset of runtime. Conversely, a good color is referred to herein as “transient” if that good color is readily subject to change during runtime. In an example, the safety bits are a single bit within a pointer, and the good safety color is persistent. For the purposes of this example, assume that 1 is the good safety color and 0 is the bad safety color. If the safety bit of a pointer encodes the value 1, then this pointer refers to the higher layer 512 runtime memory 506 in this example. On the other hand, if the safety bit of the pointer encodes the value 0, then this pointer either (a) refers to the lower layer 522 of runtime memory 506 or (b) is null.

In an embodiment, a color 544 may be encoded into a pointer to reflect the progression of a synchronization process. For example, a pointer may include a set of coloring bits allocated for indicating if this pointer refers to the correct memory location, and a new color may be designated for this set of coloring bits at the start of a synchronization process. Note that during a synchronization process, a new staged copy of a data structure may be created, and a pointer that refers to an older staged copy of the data structure may need to be remapped to the new staged copy to ensure that outdated information is not returned to a program instance. A set of coloring bits that may be used to track the progression of a synchronization process with respect to a pointer may be referred to herein as “synchronization bits” of the pointer. A value that is designated as a good color for the synchronization bits of a pointer may be referred to herein as a “good synchronization color.” In an example, the absence of a good synchronization color from the synchronization bits of a pointer indicates that this pointer may require healing. If this pointer does not refer to an unsynchronized stage object 520 in this example, then healing the pointer may simply entail storing the good synchronization color to the synchronization bits of the pointer. However, if the pointer does refer to an unsynchronized stage object 520 in this example, and if a synchronized stage object 520 has not yet been created to replace the unsynchronized stage object 520, then healing the pointer may also entail creating the synchronized stage object 520, remapping the pointer to the synchronized stage object 520, updating a forwarding table, and/or other operations. Conversely, in this example, the presence of a good synchronization color in the synchronization bits of the pointer indicates that this pointer has been confirmed to refer to the correct memory address since the beginning of an ongoing synchronization process associated with this pointer. Furthermore, in this example, if the pointer refers to a stage object 520, then presence of the good synchronization color in the synchronization bits further indicates that this stage object 520 is a synchronized stage object 520 that has been created during the ongoing synchronization process.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. LAYERED CONCURRENCY MANAGEMENT

FIG. 6 illustrates an example set of operations for layered concurrency management accordance with one or more embodiments. One or more operations illustrated in FIG. 6 may be modified, rearranged, or omitted. Accordingly, the particular sequence of operations illustrated in FIG. 6 should not be construed as limiting the scope of one or more embodiments. In an embodiment, the operations illustrated in FIG. 6 are performed in a multi-thread computing environment that is implemented in the context of at least one object-oriented programming language; to provide a cohesive explanation and consistent examples, the remainder of this Section 4 shall assume the same. However, neither a multi-thread computing environment nor an object-oriented programming language are essential or necessary to practices the techniques described herein. The techniques described herein are equally applicable to other concurrent computing architectures and other programming languages.

In one or more embodiments, the system identifies a request by a program instance to a program thread that may be attempting to cross a boundary between layers of runtime memory, and the system imposes a barrier on the program thread in response to this request (Operation 602). The request is attempting to access a specific memory address. In particular, the request is attempting to load a pointer from this specific memory address, or the request is attempting to store the pointer to this specific memory address. The specific memory address that the request is attempting to load the pointer from or store the pointer to may be allocated to some data structure in runtime memory. For example, this specific memory address may correspond to a field of a runtime object, an element of an array, or another component of some other data structure. Hereafter, the pointer that the request is attempting to load or store is referred to as “the requested pointer,” the specific memory address that the request is attempting to load the requested pointer from or write the requested pointer to is referred to as “the pointer address,” and the data structure corresponding to the pointer address is referred to as “the originating data structure.” The originating data structure may reside in a higher layer of runtime memory or a lower layer of runtime memory. The requested pointer refers to another data structure residing in runtime memory, or the requested pointer is null. Hereafter, the other data structure that may be referenced by the requested pointer (i.e., if the requested pointer is not null) is referred to as “the target data structure.” If the requested pointer is not null, then the target data structure resides in the higher layer of runtime memory of the lower layer of runtime memory.

In one or more embodiments, the program thread, acting pursuant to the barrier, determines if the originating data structure resides in the lower layer of runtime memory, and the program thread proceeds to another operation based on this determination (Operation 604). In other words, the program thread is determining if the requested pointer originates from the lower layer of runtime memory. If the originating data structure resides in the lower layer of runtime memory, then the program thread proceeds to Operation 606. In this scenario, the requested pointer is a safe-to-fast pointer, a safe-to-safe pointer, or a safe-to-null pointer, and the barrier will direct the program thread to apply the safety-intensive policy. Alternatively, if the originating data structure resides in the higher layer of runtime memory, then the program thread proceeds to Operation 610. In this alternative scenario, the requested pointer is a fast-to-fast pointer, a fast-to-safe pointer, or a fast-to-null pointer, and the barrier may direct the program thread to apply the performance-intensive policy or the safety-intensive policy.

In an embodiment, the program thread, acting pursuant to the barrier, determines if the originating data structure resides in the lower layer of runtime memory based on the coloring of another pointer that refers to the originating data structure. For instance, the program thread may determine if the originating data structure resides in the lower layer of runtime memory based on the safety bits of this other pointer. As noted above, the safety bits of a pointer are a set of non-address bit(s) in the pointer allocated, at least in part, for indicating if this pointer resides in a higher layer of runtime memory. In particular, the program thread may determine if the originating data structure resides in the lower layer of runtime memory by comparing the coloring of the safety bits in this other pointer to the good color for the safety bits. To facilitate this comparison, the good color for the safety bits may be encoded into the barrier, stored in a thread-local storage mechanism of the program thread, stored in a global storage mechanism, and/or maintained in some other location that is readily accessible to the program thread while executing the barrier. Here, if the safety bits of this other pointer encode a good color, then the program thread may conclude that the data structure that is referenced by this other pointer (i.e., the originating data structure) is a safe data structure residing in the higher layer of runtime memory. Note that the inverse may or may not be true depending on how the designation of good colors and the coloring of the safety bits is implemented. For example, if the good color for the safety bits is a transient color (i.e., subject to change), then the safety bits of this other pointer encoding a bad color or no color may indicate that it is currently unconfirmed whether or not the originating data structure resides in the higher layer of runtime memory. Rather, in this example, the safety bits of the other pointer encoding a bad color or no color may simply indicate that the other pointer has not been loaded since the good color for the safety bits was last reset. In another example, the good color for the safety bits is a persistent color (i.e., constant). If the safety bits of the other pointer encode a bad color in this other example, then the program thread may conclude that the originating data structure resides in the lower layer of runtime memory.

In an embodiment, the program thread, acting pursuant to the barrier, determines if the originating data structure resides in the lower layer of runtime memory based on the executable instructions of the program instance. In this embodiment, the system may require a task manipulating a data structure in the lower layer of runtime memory to be defined in source code in terms of specific reference types, keywords, arguments, and/or other syntax that identifies the task as being directed to the lower layer of runtime memory. As a result, whether or not the target data structure resides in the lower layer of runtime memory may be implicit in the executable instructions of the program instance's request. In an example, the system mandates that (a) a runtime object residing in the lower layer of runtime memory be an instance of an unsafe class and/or (b) a field of a runtime object residing in the lower layer of runtime memory be qualified with an unsafe keyword. Therefore, in this example, it may be apparent from the moment that source code of the program instance is compiled whether or not the originating data structure will reside in the lower layer of runtime memory. Accordingly, in this example, the program thread may be able to determine if the originating data structure resides in the lower layer of runtime memory based on the executable instructions of the program instance, at least in some cases. However, while the system may require specific syntax to utilize lower-layer data structures, it still may not be clear from the executable instruction of the program instance whether a given data structure resides in the lower layer of runtime memory in some cases. For example, some data structures, such as arrays, may introduce additional complexities that obscure whether or not an element of the array resides in the lower layer of runtime memory.

In one or more embodiments, the program thread, acting pursuant to the barrier, determines if the target data structure resides in the lower layer of runtime memory or the requested pointer is null, and the program thread proceeds to another operation based on this determination (Operation 606). In other words, the program thread is determining if the requested pointer references the lower layer of runtime memory. In this scenario, the program thread has already determined that the originating data structure is in the lower layer of runtime memory. Thus, if the target data structure also resides in the lower layer of runtime memory or the requested pointer is null, then the requested pointer does not cross the boundary between the higher layer of runtime memory and the lower layer of runtime memory. As noted above, requests that stay within the confines of the lower layer of runtime memory are generally not subjected to the safety-intensive policy. Accordingly, if the target data structure resides in the lower layer of runtime memory or the requested pointer is null, then the program thread proceeds to Operation 608. In this scenario, the requested pointer is a fast-to-fast pointer or a fast-to-null pointer, and the barrier will direct the program thread to apply the performance-intensive policy to the request. Alternatively, if the target data structure resides in the higher layer of runtime memory, then the program thread proceeds to Operation 612. In this alternative scenario, the requested pointer is a fast-to-safe pointer, and the barrier will direct the program thread to apply the safety-intensive policy.

In an embodiment, the program thread, acting pursuant to the barrier, determines if the target data structure resides in the lower layer of runtime memory based on the coloring of the requested pointer. For instance, the program thread may determine if the target data structure resides in the lower layer of runtime memory based on the safety bits of the requested pointer. In particular, the program thread may determine if the target data structure resides in the lower layer of runtime memory by comparing the coloring of the safety bits in the requested pointer to the good color for the safety bits. To facilitate this comparison, the good color for the safety bits may be encoded into the barrier, stored in a thread-local storage mechanism of the program thread, stored in a global storage mechanism, and/or maintained in some other location that is readily accessible to the program thread while executing the barrier. Here, if the safety bits of the requested pointer encode a good color, then the program thread may conclude that the data structure that is referenced by the requested pointer (i.e., the target data structure) is a safe data structure residing in the higher layer of runtime memory. Note that the inverse may or may not be true depending on how the designation of good colors and the coloring of the safety bits is implemented. For example, if the good color for the safety bits is a transient color (i.e., subject to change), then the safety bits of the requested pointer encoding a bad color or no color may indicate that it is currently unconfirmed whether or not the target data structure resides in the higher layer of runtime memory. Rather, in this example, the safety bits of the requested pointer encoding a bad color or no color may simply indicate that the requested pointer has not been loaded since the good color for the safety bits was last reset. In another example, the good color for the safety bits is a persistent color (i.e., constant). If the safety bits of the requested pointer encode a bad color in this other example, then the program thread may conclude that the target data structure resides in the lower layer of runtime memory.

In an embodiment, the program thread, acting pursuant to the barrier, determines if the target data structure resides in the lower layer of runtime memory based on the executable instructions of the program instance. In this embodiment, the system may require a task manipulating a data structure in the lower layer of runtime memory to be defined in source code in terms of specific reference types, keywords, arguments, and/or other syntax that identifies the task as being directed to the lower layer of runtime memory. As a result, whether or not the target data structure resides in the lower layer of runtime memory may be implicit in the executable instructions of the program instance's request. In an example, the system mandates that (a) a runtime object residing in the lower layer of runtime memory be an instance of an unsafe class and/or (b) a field of a runtime object residing in the lower layer of runtime memory be qualified with an unsafe keyword. Therefore, in this example, it may be apparent from the moment that source code of the program instance is compiled whether or not the target data structure will reside in the lower layer of runtime memory. Accordingly, in this example, the program thread may be able to determine if the target data structure resides in the lower layer of runtime memory based on the executable instructions of the program instance, at least in some cases.

In one or more embodiments, the program thread, acting pursuant to the barrier, determines if the performance-intensive policy permits the request, and the program thread proceeds to another operation based on this determination (Operation 608). In this scenario, the program thread is applying the performance-intensive policy to the request because (a) the originating data structure resides in the lower layer of runtime memory and (b) the requested pointer does not cross into the higher layer of runtime memory. For instance, in this scenario, the requested pointer may be a fast-to-fast pointer or a fast-to-null pointer. As noted above, the performance-intensive policy may define (a) criteria for permissible requests and/or (b) procedures for executing permissible requests. Here, the program thread is determining if the request satisfies the performance-intensive policy's criteria for permissible requests. The performance-intensive policy's criteria for permissible requests may vary between embodiments. If the performance-intensive policy does not specify any criteria for permissible requests, then the program thread proceeds to Operation 610. Similarly, if the performance-intensive policy does specify criteria for permissible requests, and if the request satisfies this criteria, then the program thread proceeds to Operation 610. In these scenarios, the program thread may attempt to execute the request in accordance with the performance-intensive policy's procedures for executing permissible requests. Alternatively, if the request does not satisfy the performance-intensive policy's criteria for permissible request, then the program thread proceeds to Operation 616.

In one or more embodiments, the program thread, acting pursuant to the barrier, executes the request in accordance with performance-intensive policy's procedures for executing permissible requests (Operation 610). As noted above, the performance-intensive policy is generally configured for better program performance. Therefore, any concurrency-safety mechanisms that are applied while executing the request pursuant to the performance-intensive policy will generally be less extensive than the concurrency-safety mechanisms that might be applied while executing this same request pursuant to the safety-intensive policy. Example concurrency-safety mechanisms that the safety-intensive policy may direct the program thread to utilize while completing the request include concurrency checks, version controls, staging areas, memory transactions, synchronization procedures, memory fencing, locks, atomic operations, memory-visibility mechanisms, and other concurrency-safety mechanisms.

In an embodiment, the performance-intensive policy permits the program thread to directly manipulate runtime objects residing in the lower layer of runtime memory while executing the request. As an example, assume that the request is attempting to store the requested pointer to the pointer address, and further assume that the pointer address corresponds to a field of a shared object (i.e., the originating object) residing in the lower layer of runtime memory. In this example, the program thread writes the requested pointer directly to this field of the shared object. The program thread does not stage the execution of the request in a staging area in this example.

In an embodiment, the performance-intensive policy specifies that the program thread executes memory fencing operations while executing the request. For example, if the request is attempting to load the pointer from the pointer address, then the barrier is a load barrier, and the program thread may execute a load fence as part of the load barrier. In another example, the request is attempting to store the pointer to the pointer address, and the barrier is a store barrier. In this other example, the program thread executes a store fence as part of the store barrier.

In one or more embodiments, the program thread, acting pursuant to the barrier, determines if the safety-intensive policy permits the request, and the program thread proceeds to another operation based on this determination (Operation 612). In this scenario, the program thread is applying the safety-intensive policy because one or both of the originating data structure and the target data structure reside in the higher layer of runtime memory. In this scenario, the request may or may not be attempting to cross the boundary between the higher layer of runtime memory and the lower layer of runtime boundary. For instance, in this scenario, the request may be a fast-to-safe pointer, a safe-to-fast pointer, a safe-to-safe pointer, or a safe-to-null pointer. As noted above, the safety-intensive policy may define (a) criteria for permissible requests and/or (b) procedures for executing permissible requests. Here, the program thread is determining if the request satisfies the safety-intensive policy's criteria for permissible requests. The safety-intensive policy's criteria for permissible requests may vary between embodiments. If the safety-intensive policy does not specify any criteria for permissible requests, then the program thread proceeds to Operation 614. Similarly, if the safety-intensive policy does specify criteria for permissible requests, and if the request satisfies this criteria, then the program thread proceeds to Operation 614. In these scenarios, the program thread may attempt to execute the request in accordance with the safety-intensive policy's procedures for executing permissible requests. Alternatively, if the request does not satisfy the safety-intensive policy's criteria for permissible request, then the program thread proceeds to Operation 616.

In an embodiment, the safety-intensive policy prohibits a load or store operation that (a) is targeting a non-direct-write field and (b) is attempting to cross the boundary between the higher layer of runtime memory and the lower layer of runtime memory. In other words, the safety-intensive policy of this embodiment prohibits loading an inter-layer pointer from a non-direct field and/or storing an inter-layer pointer to a non-direct field. A safe-to-fast pointer and a fast-to-safe pointer are examples of inter-layer pointers. As an example, assume that pointer address corresponds to a non-volatile (i.e., non-direct-write) field of a runtime object (i.e., the originating data structure). If the requested pointer is a fast-to-safe pointer or a safe-to-fast pointer in this example, then the request is prohibited by the safety-intensive policy in this example. In another embodiment, the safety-intensive policy permits a load or store operation that (a) is targeting a non-direct-write field and (b) is attempting to cross the boundary between the higher layer of runtime memory and the lower layer of runtime memory.

In an embodiment, the safety-intensive policy prohibits a pointer that refers to a data structure residing in the higher layer of runtime memory from being stored to a data structure that resides in the lower layer of runtime memory. As an example, assume that the request is attempting to store the requested pointer to the pointer address, and further assume that the originating data structure resides in the lower layer of runtime memory. If the target data structure resides in the higher layer of runtime memory in this example, then the safety-intensive policy prohibits the request. In other words, if the requested pointer is a fast-to-safe pointer, then the request is prohibited by the safety-intensive policy in this example. In another embodiment, the safety-intensive policy permits a pointer that refers to a data structure residing in the higher layer of runtime memory to be stored to a data structure that resides in the lower layer of runtime memory.

In one or more embodiments, the program thread, acting pursuant to the barrier, executes the request in accordance with safety-intensive policy's procedures for executing permissible requests (Operation 612). As noted above, the safety-intensive policy is generally configured for greater concurrency safety. Therefore, any concurrency-safety mechanisms that are applied while executing the request pursuant to the safety-intensive policy will generally be more extensive than the concurrency-safety mechanisms that might be applied while executing this same request pursuant to the performance-intensive policy. Example concurrency-safety mechanisms that the safety-intensive policy may direct the program thread to utilize while completing the request include concurrency checks, version controls, staging areas, memory transactions, synchronization procedures, memory fencing, locks, atomic operations, memory-visibility mechanisms, and other concurrency-safety mechanisms.

In an embodiment, the safety-intensive policy prevents the program thread from directly manipulating the originating data structure while executing the request. For instance, instead of directly manipulating the originating data structure the barrier may direct the program thread stage the execution of the request in a staging area. As an example, assume that the request is attempting to store the requested pointer to the originating data structure. In this example, the barrier redirects the program thread's execution of the request to operate on a staged copy of the originating data structure that resides in the current staging area of the program thread. If there is not a staged copy of the originating data structure in the program thread's current staging area at this time, then the barrier may direct the program thread to create a staged copy of the originating data structure in the current staging area of the program thread. In this example, the program thread executes the request by storing the requested pointer to the staged copy of the originating object (i.e., not the pointer address). At this time, program thread of this example may be directed to synchronize any mutations that have been applied to the stage objects in the current staging area of the program thread with any mutations that have been applied to the corresponding canonical objects, or this synchronization process may be delayed until the next synchronization trigger. In the latter example scenario, the program thread may proceed onward with executing a next request of the program instance.

In an embodiment, the safety-intensive policy specifies that the program thread (a) stage the execution of the request on a staged copy of the originating data structure and then (b) attempt to synchronize any divergent mutations between the originating data structure and the staged copy of the originating data structure. As an example, assume that the request is attempting to store the requested pointer to the originating data structure. After staging the performance of request on a staged copy of the data structure, the barrier of this example may direct the program thread to synchronize (a) any mutations that have been applied to the originating data structure by other threads since the program thread created the staged copy of the originating data structure with (b) any staged mutations that have been applied to the staged copy of the originating data structure. In synchronizing these mutations in this example, the program thread creates a new staged copy of the originating data structure. The program thread may create this new staged copy of the originating data structure in a new staging area that is allocated for the program thread in this example. In other words, the program thread may rebase itself in this example. After finishing the synchronization process in this example, the program thread may be permitted to update the originating data structure to match the state of the new staged copy of the originating data structure.

In an embodiment, the safety-intensive policy specifies that the program thread perform concurrency check(s) while executing the request. As an example, assume that the barrier directs the program thread to stage the execution of the request and then synchronize (a) any mutations that have been applied to the originating data structure by other threads with (b) any staged mutations that have been applied to a staged copy of the originating data structure by the program thread. During the synchronization process in this example, the barrier may direct the program thread to determine if there are any conflicts between these two sets of mutations (i.e., a concurrency check). If any of the mutations applied to the originating data structure conflict with any of the staged mutations applied to the staged copy of the originating data structure in this example, then the barrier may direct the program thread to abort this attempted synchronization process. In this example scenario, the barrier may direct the program thread to create a new staged copy of the originating data structure and make another attempt at staging the execution of the request.

In an embodiment, the safety-intensive policy specifies that the program thread apply version controls while staging the execution of the request, synchronizing divergent mutations, and/or performing concurrency checks. For example, after staging the execution of the requested on a staged copy of the originating data structure, the barrier may direct the program thread to determine of the originating data structure should be synchronized with the staged copy based on determining if the originating data structure now corresponds to a different version than the staged copy. In this example, the program thread may conclude that originating data structure and the staged copy correspond to different version if the originating data structure and the staged object are linked to different commit objects.

In one or more embodiments, the barrier prevents or delays the program thread from executing the request (Operation 616). In this scenario, the barrier prevents or delays the program thread from executing the request because the request was prohibited by either the performance-intensive policy or the safety-intensive policy. Additionally, or alternatively, the barrier may direct the program thread to perform other corrective actions such as terminating the program instance and/or flagging this policy violation to a user.

### 5. EXAMPLE EMBODIMENT

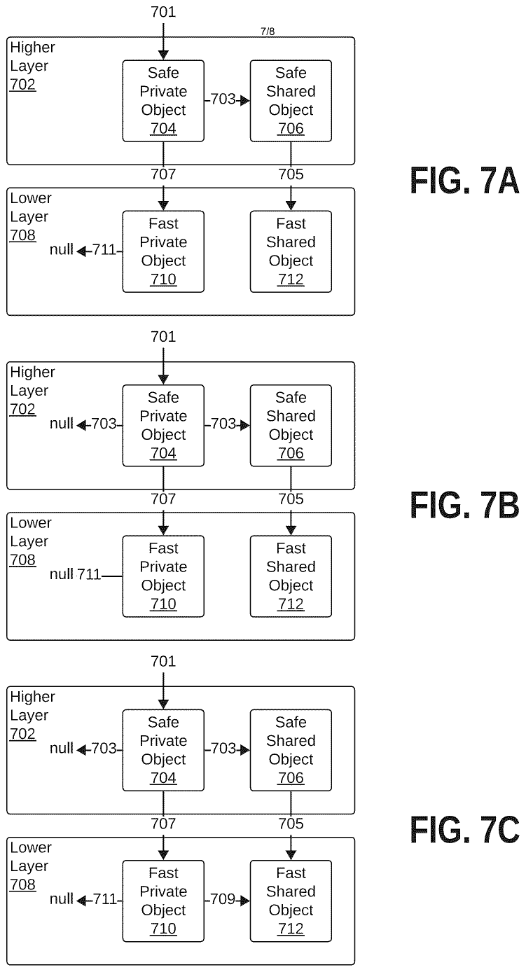

FIG. 7A, FIG. 7B, and FIG. 7C illustrate a simplified example of a runtime memory 700 where techniques for layered memory management may be practiced in accordance with an example embodiment. For clarity in explanation, supporting data structures such as staged objects, commit objects, and branch object, are not illustrated in FIG. 7A, FIG. 7B, and FIG. 7C. A detailed example is described below for purposes of clarity. Components and/or operations described below should be understood as one specific example which may not be applicable to certain embodiments. Accordingly, components and/or operations described below should not be construed as limiting the scope of any of the claims. Pointers are represented in FIGS. 7A and 7B as arrows. For the purposes of this example, assume that any given pointer illustrated in FIGS. 7A and 7B will include a safety bit that has been colored to include either a good safety color or a bad safety color, and further assume that the good safety color is the value “1.” In particular, if a pointer refers to the higher layer 702 of runtime memory 700, then the safety bit of that pointer include the good safety value in this example. If a pointer (a) refers to the lower layer 708 of runtime memory 700 or (b) is null, then the safety bit of that pointer will include the bad safety color. Accordingly, it may be determined what concurrency management policy should be applied to a request that is attempting to load or store a particular pointer in a runtime object based on (a) the color encoded into a safety bit of a pointer that refers to the runtime object (referred to hereafter as “the originating color”) and (b) the color encoded into the safety bit of the particular pointer (referred to hereafter as “the referent color”). Specifically, it may be determined what concurrency management policy should be applied to a request attempting to load or store a particular pointer to a particular object by determining the maximum value of (a) the originating color encoded into the safety bit of the particular pointer and (b) the referent color encoded into the safety bit of another pointer that refers to the particular object. If this maximum value of the originating color and the referent color is equal to one in this example, then a safety-intensive policy should be applied to the request. Alternatively, if this maximum value is zero, then a performance-intensive policy should be applied to the request. Additionally, or alternatively, it may be determined what concurrency management policy should be applied to a request that is attempting to load or store a particular pointer in a runtime object based on executable instructions corresponding to the request.

In an example embodiment, a first barrier is imposed on a program thread in response to a first request by a program instance instructing the program thread to load pointer 701. FIG. 7A illustrates the state of runtime memory 700 at the time the first barrier is imposed on the program thread. While executing the first barrier, the program thread inspects the color of the safety bit in pointer 701. The safety bit of pointer 701 encodes the good safety color (i.e., 1). Since the request is attempting to load or store pointer 701, the good safety color is the referent color. Since pointer 701 originates from outside of runtime memory 700, therefore there is no other pointer that can be inspected to determine an originating color. Notwithstanding, the maximum of the originating color (i.e., N/A) and the referent color (i.e., 1), is equal to 1. Therefore, the first barrier will therefore instruct the program thread to apply the safety-intensive policy to the first request.

In an example embodiment, a second barrier is imposed on the program thread in response to a second request by the program instance instructing the program thread to load pointer 703. FIG. 7A illustrates the state of runtime memory 700 at the time the second barrier is imposed on the program thread. As illustrated in FIG. 7A, pointer 703 is a safe-to-safe pointer. With respect to the second request, the color encoded into pointer 701 can be relied on as the originating color, and the color encoded into pointer 703 can be relied on as the referent color. As noted above, the safety bit of pointer 701 encodes the goods safety color (i.e., 1). While executing the second barrier, the program thread inspects the coloring of the safety bit in pointer 703. Since pointer 703 refers to a safe object, the safety bit of pointer 703 also encodes the good safety color (i.e., 1). Thus, the maximum of the originating color (i.e., 1) and the referent color (i.e., 1) is equal to 1. Based on the foregoing, the logic of the second barrier can conclude that the second request is attempting to load a safe-to-safe pointer, and the second barrier will therefore instruct the program thread to apply the safety-intensive policy to the second request.

In an example embodiment, a third barrier is imposed on the program thread in response to a third request by the program instance instructing the program thread to load pointer 705. FIG. 7A illustrates the state of runtime memory 700 at the time the third barrier is imposed on the program thread. As illustrated in FIG. 7A, pointer 705 is a safe-to-fast pointer. With respect to the third request, the color encoded to the safety bit of pointer 703 can be relied on as the originating color, and the color encoded to the safety bit of pointer 705 can be relied on as the referent color. As noted above, the safety bit of pointer 705 encodes the good safety color (i.e., 1). While executing the third barrier, the program thread inspects the coloring of the safety bit in pointer 705. Since pointer 705 refers to a fast object, the safety bit of pointer 705 encodes the bad color (i.e., 0). Thus, the maximum of the originating color (i.e., 1) and the referent color (i.e., 0) is equal to 1. Based on the foregoing, the logic of the third barrier can conclude that the third request is attempting to load either a safe-to-fast pointer or a safe-to-null pointer, and the third barrier will therefore instruct the program thread to apply the safety-intensive policy to the third request.

In an example embodiment, a fourth barrier is imposed on the program thread in response to a fourth request by the program instance instructing the program thread to remap pointer 703 to null. FIG. 7A illustrates the state of runtime memory 700 at the time the fourth barrier is imposed on the program thread. With respect to the fourth request, the color encoded to the safety bit of pointer 701 can be relied on as the originating color. The color that is currently stored to the safety bit of pointer 703 cannot be relied on as the referent color because the fourth request is remapping pointer 703. Therefore, while executing the fourth barrier, the program thread inspects the executable instructions of the fourth request, and the program thread determines that pointer 703 will be remapped to null if the fourth request is successfully executed. As noted above, the safety bit of a null pointer will be encoded with the bad safety color (i.e., 0). Accordingly, the bad safety color can be relied on as the referent color of the fourth request. Thus, the maximum of the originating color (i.e., 1) and the referent color (i.e., 0) is equal to 1. Based on the foregoing, the logic of the fourth barrier can conclude that the fourth request is attempting to load either a safe-to-fast pointer or a safe-to-null pointer, and the fourth barrier will therefore instruct the program thread to apply the safety-intensive policy to the fourth request. While executing the fourth request to remap pointer 703 to null, the fourth barrier further instructs the thread to update the safety bit of pointer 703 to encode the bad safety color.

In an example embodiment, a fifth barrier is imposed on the program thread in response to a fifth request by the program instance instructing the program thread to load pointer 707. FIG. 7B illustrates the state of runtime memory 700 at the time the fifth barrier is imposed on the program thread. As illustrated in FIG. 7B, pointer 707 is a safe-to-fast pointer. With respect to the fifth request, the color encoded to the safety bit of pointer 701 can be relied on as the originating color, and the color encoded to the safety bit of pointer 707 can be relied on as the referent color. As noted above, the safety bit of pointer 701 encodes the good safety color (i.e., 1). While executing the third barrier, the program thread inspects the coloring of the safety bit in pointer 707. Since pointer 707 refers to a fast object, the safety bit of pointer 707 encodes the bad color (i.e., 0). Thus, the maximum of the originating color (i.e., 1) and the referent color (i.e., 0) is equal to 1. Based on the foregoing, the logic of the fifth barrier can conclude that the fifth request is attempting to load either a safe-to-fast pointer or a safe-to-null pointer, and the fifth barrier will therefore instruct the program thread to apply the safety-intensive policy to the fourth request.

In an example embodiment, a sixth barrier is imposed on the program thread in response to a sixth request by the program instance instructing the program thread to write pointer 709 to a field of fast private object 710. FIG. 7B illustrates the state of runtime memory 700 at the time the fifth barrier is imposed on the program thread. Pointer 709 will refer to fast shared object 712. Therefore, pointer 711 will be a fast-to-fast pointer. With respect to the sixth request, the color encoded to the safety bit of pointer 707 can be relied on as the originating color. As noted above, the safety bit of pointer 707 encodes the bad safety color (i.e., 0) While executing the fourth barrier, the program thread inspects the executable instructions of the sixth request, and the program thread determines that pointer 703 will be remapped to a fast object if the sixth request is successfully executed. As noted above, the safety bit of a pointer referring to the lower layer 708 of runtime memory 700 will be encoded with the bad safety color (i.e., 0). Accordingly, the bad safety color can be relied on as the referent color of the sixth request. Thus, the maximum of the originating color (i.e., 0) and the referent color (i.e., 0) is equal to the value 0. Therefore, the logic of the sixth barrier may assume that pointer 709 will be a fast-to-fast pointer or a fast-to-null pointer, and the sixth barrier will therefore instruct the program thread to apply the performance-intensive policy to the sixth request. While executing the sixth request, the sixth barrier further instructs the program thread to store the bad safety color to the safety bit of pointer 709.

In an example embodiment, a seventh barrier is imposed on the program thread in response to a seventh request by the program instance instructing the program thread to load pointer 711. FIG. 7C illustrates the state of runtime memory 700 at the time the seventh barrier is imposed on the program thread. As illustrated in FIG. 7C, pointer 711 is a safe-to-fast pointer. With respect to the seventh request, the color encoded to the safety bit of pointer 707 can be relied on as the originating color, and the color encoded to the safety bit of pointer 711 can be relied on as the referent color. As noted above, the safety bit of pointer 707 includes the bad safety color (i.e., 1). While executing the seventh barrier, the program thread inspects the color of the safety bit in pointer 711, and the program thread determines that the safety bit of pointer 711 encodes the bad safety color (i.e., 1). Thus, the maximum of the originating color (i.e., 0) and the referent color (i.e., 0) is equal to the value 0. Therefore, the logic of the seventh barrier may assume that pointer 711 is a fast-to-fast pointer or a fast-to-null pointer, and the seventh barrier will therefore instruct the program thread to apply the performance-intensive policy to the seventh request.

### 6. PRACTICAL APPLICATIONS, ADVANTAGES, AND IMPROVEMENTS

Embodiments of the present disclosure provide several practical applications, advantages, and improvements over existing architectures for managing concurrent computing operations. These practical applications, advantages, and improvements include policy-driven concurrency control, concurrency safety, deterministic failure handling, simplified diagnostics, cost efficiency, backwards compatibility, operational flexibility, and others. As an illustrative example, some of these practical applications, advantages, and improvements are described below in the context of a multi-thread computing environment that is implemented using at least one object-oriented programming language. However, neither a threaded computing environment nor an object-oriented programming language are essential or necessary to realize these practical applications, advantages, and improvements. By practicing the techniques described herein, these practical applications, advantages, and improvements may be realized in the context of other computing architectures and/or other programming languages.

One or more embodiments implement granular concurrency safety by organizing runtime memory into a higher layer that is associated with a safety-intensive policy for concurrency management and a lower layer that is associated with a performance-intensive policy for concurrency management. Program tasks involving higher-layer addresses are generally subjected to the more rigorous concurrency-safety mechanisms specified by the safety-intensive policy, whereas program tasks involving lower-layer addresses may be subjected to less rigorous concurrency-safety mechanisms specified by the performance-intensive policy. As a result, a developer may define source code of a program such that (a) program tasks that warrant greater safety operate on higher-layer data structures subject to the safety-intensive policy and (b) program tasks that warrant prioritizing program performance operate on lower-layer data structures subject to the performance-intensive policy. At the same time, the system monitors interactions between the higher and lower layers of runtime memory to ensure that (a) program tasks originating from the lower layer do not undermine the concurrency-safety guarantees of the higher layer and (b) program tasks originating from the higher layer do not erode the performance benefits of the lower layer.

One or more embodiments prevent concurrency issues by compelling program threads to interact with shared objects indirectly through staged copies of the shared objects that are created in isolated staging areas. For instance, when a program thread attempts to complete a program task that involves interacting with a shared object at the behest of a program instance, the system may compel the program thread to create a staged copy of this shared object (i.e., a stage object) in an isolated staging area of the program thread. After the stage object is created, the system redirects execution of the program task to operate on the stage object rather than on the shared object. Since the stage object is inaccessible to other threads, the program thread is free to execute the program task on the stage object without risk of another thread's concurrent activities interfering with the program thread's performance of the program task. For example, since the other threads cannot access the stage object, there is no risk of the program thread being insnared in an infinite loop or other concurrency issue that could otherwise arise if another thread was capable of concurrently mutating a field of the stage object that is a basis for performing the program task. When the program thread completes the program task on the stage object, the program thread may be permitted to publish any changes that have been made to the stage object to a shared area of runtime memory by updating the shared object to match the state of the stage object. Prior to committing these changes to the shared area, the system may compel the program thread to check if any other threads have published any conflicting mutations to the shared area since the program thread initially created the stage object in the program thread's staging area. If there are no conflicting mutations, then the system may permit the program thread to publish these changes to the shared area. If there are conflicting mutations, then the system may prevent the program thread from publishing these changes, and the system may compel the program thread to restart the program task with a new staged copy of the shared object and/or perform other corrective actions. By preventing the program thread from publishing the conflicting changes to the shared area, the system prevents potential concurrency issues that might otherwise arise from the uncertainty and inconsistency in the shared area that would result from publishing these conflicting changes.

By staging the performance of program tasks that involve interacting with shared objects in isolated staging areas of runtime memory, one or more embodiments ensure deterministic failure handling and avoid harmful side effects that might otherwise result from partial completions of these program tasks in shared memory. As noted above, the system compels a program thread to perform a program task involving a shared object on a staged copy of the shared object (i.e., a stage object) maintained in an isolated staging area rather than directly on the shared object itself. Upon completion of the program task on the stage object, the program thread may be permitted to commit changes made to the stage object to the shared area if the system determines that those changes do not conflict with any intervening updates committed to the shared area by other threads while the program thread was staging the performance of the program task. If a conflict is detected, the system prevents the program thread from committing the changes to the shared area. Since the program task is executed on the stage object in the staging area, no partial or intermediate mutations are applied to the shared object prior to conflict detection. As a result, aborting the commit does not require reversing, compensating for, or rolling back any operations previously performed by the program thread while staging the performance of the program task. This deferred synchronization model ensures deterministic failure handling by allowing failed execution attempts to be discarded without impacting the state of shared memory. After an aborted commit, the program thread can simply restart the program task by obtaining a new staged copy of the shared object and re-executing the task, thereby ensuring correctness while avoiding memory corruption and inconsistent shared state.

One or more embodiments reduce the cost of implementing concurrency safety via staged interactions with shared data structures by lazily synchronizing any changes made to separate copies of the shared data structures and coloring pointers to track the progression of this synchronization process. For instance, in the course of a synchronization process, the system may refrain from directing a program thread to synchronize any changes made to a shared object with any changes made to a staged copy of this shared object (i.e., a stage object) until if and when a new synchronized copy of the shared object is currently needed to continue program execution. By directing a program thread to lazily synchronize changes in this manner, the system reduces the amount of work that is done by the program thread to implement concurrency safety via staged interactions with shared data structures. Minimizing the amount of work that is done by a program thread to implement concurrency safety via staged interactions with shared data structures reduces the impact that concurrency safety has on program performance. The system compels the program thread to stage these interactions via barriers that are inserted into the executable instructions of a program instance that is being executed by the program thread. To keep track of what runtime objects and references have been lazily synchronized during a synchronization process, the system directs the program thread to color pointers while staging interactions with shared objects. For instance, when the program thread attempts to load a pointer that refers to a stage object at the behest of a program instance, the system may impose a barrier on the program thread that directs the program thread to consult the coloring of the pointer to determine if this pointer and/or this stage object have been synchronized as part of the ongoing synchronization process. Since the information that is needed to make this determination is encoded into the pointer that the program thread is already loading at the behest of the program instance and/or the barrier that is directly inserted into the executable instructions of the program instance, this determination can be made by the program thread with minimal computational cost and disruption to program execution. Considering that these barriers that may be inserted into the executable instructions of the program instance for any given load operation and/or write operation, this reduction in computational cost and disruption to program execution may be highly significant for rendering concurrency safety via staged interactions feasible in production environments.

By staging the performance of program tasks that involve interacting with shared objects in isolated staging areas of runtime memory, one or more embodiments reduce the cost of implementing concurrency safety. As noted above, the system compels a program thread to perform a program task involving a shared object on a staged copy of the shared object (i.e., a stage object) maintained in an isolated staging area, rather than operating directly on the shared object itself. Staging the performance of the program task in this manner allows the program thread to perform the program task optimistically. In particular, the program thread is free to perform the program task without having to coordinate the program thread's activities with the concurrent activities of the other threads. As a result, the cost that would otherwise be incurred by the program thread in coordinating with other threads while completing the program task is avoided. Upon completion of the program task on the stage object, the program thread may be permitted to commit changes made to the stage object to the shared area if these changes do not conflict with any intervening updates committed to the shared area by other threads while the program thread was staging the performance of the program task. Staging the performance of the program task in this manner will result in a cost savings unless it so happens that the changes made to the staged object conflict with other changes that have been published to the shared area. If such conflicts do exist, then the system may direct the program thread to restart the program task with a new staged copy of the shared object, and the cost of restarting the program task might outweigh the cost savings associated with optimistically performing the program task. However, such conflicts are generally uncommon. Therefore, on aggregate, the cost savings from optimistically performing program tasks will typically outweigh the cost that is incurred by restarting program tasks due to conflicts.

One or more embodiments simplify diagnosing a causality bug in a program instance by detecting and flagging manifestations of a causality bug even where these manifestations do not necessarily result in externally observable incorrect behavior. Note that a manifestation of a causality bug, such as conflicting mutations to the same memory location, does not necessarily spawn an evident concurrency issue. If the benign manifestations of a causality bug are not detected, a causality bug can appear to a developer as manifesting itself infrequently and at random, and diagnosing this causality bug based on these seemingly sporadic manifestations can be difficult and time consuming. However, by compelling program threads to check for conflicting mutations at any given synchronization attempt between a shared area of runtime memory and a staging area of runtime memory, the system detects conflicting mutations that result from a causality bug even where there conflicting mutations do not result in a concurrency issue or are prevented from causing a concurrency issue by the system. By flagging these conflicting mutations to a developer as manifestations of a causality bug regardless of whether these conflicts spawn a concurrency issue, the system may significantly simplify the identification and diagnosis of the causality bug.

By staging the performance of program tasks that involve interacting with shared objects in isolated staging areas of runtime memory, one or more embodiments may reduce reliance on locks during program execution. While a program thread is performing a program task on a staged copy of a shared object (i.e., a stage object) in an isolated staging area, the program thread need not acquire a lock on the stage object because the stage object is inaccessible to other threads. Acquisition of a lock on the shared object may be deferred to a singular occasion where the state of the shared object is updated to match the state of the stage object following the completion of the program task. In contrast, maintaining concurrency safety while performing this same program task directly on the shared object instead of the staged object might involve acquiring and releasing a lock on the shared object on multiple occasions throughout the performance of the program task. Accordingly, staging the performance of the program task may significantly reduce the program thread's reliance on locks while actively executing program tasks. By reducing reliance on locks while actively performing program tasks, the system may avoid lock convoying, mitigate priority inversion, prevent deadlocks, reduce the time that is spent in kernel-level synchronization, and/or otherwise alleviate performance and correctness challenges commonly associated with greater reliance on locks.

One or more embodiments track the different versions of a shared data set created by separate program threads executing a program instance and detect causality bugs in the program instance by identifying merge conflicts between the different versions of the shared data set. For instance, the system may allow program threads to create isolated copies of the same set of runtime objects in staging areas of runtime memory that are respectively allocated to the program threads, and the system allows the program threads to create different versions of the set of runtime objects by mutating these isolated copies. At the same time, a shared copy of the set of runtime objects is maintained in a shared area of runtime memory. For any given copy of the set of runtime objects that resides in a staging area or the shared area, the system tracks the version of the set of runtime objects that this given copy corresponds to. By independently tracking the multiple versions of the multiple copies of the set of runtime objects, the system can discern if two separate copies of the set of runtime objects potentially include conflicting mutations. If separate copies of the set of runtimes potentially include conflicting mutations, the system compares mutations that have been applied to these separate copies to determine if there are, in fact, any conflicting mutations. If the system identifies conflicting mutations to separate copies of the set of runtime objects, the system has identified a manifestation of a causality bug in the program instance. Upon identifying a causality bug in the program instance, the system flags this causality bug, so this causality bug can be remedied by a developer of the program instance. Note that conflicting mutations to same memory location do not necessarily create an evident concurrency issue. Accordingly, the concurrency issues spawned by a causality bug may seem to appear infrequently and randomly during program execution. The sporadic appearances of concurrency issues that result from a causality bug can make it difficult and time consuming to diagnose and resolve that causality bug. However, using the techniques described herein, the system may detect manifestations of a causality bug in a program instance where these manifestations do not necessarily result in an evident concurrency issue. As a result, the system may greatly simplify diagnosing a causality bug whose manifestations might go unnoticed except where these manifestations result in an evident concurrency issue.

One or more embodiments track a happens-before ordering of versions of a shared data set and reference this happens-before ordering to detect, prevent, and diagnose potential concurrency issues. For instance, when a program thread creates a new version of a set of runtime objects by synchronizing a shared copy of the set of runtime objects with an isolated copy of the set of runtime objects, the system generates a commit object to represent this new version of the set of runtime objects. Furthermore, the system adds this commit object to an object graph of commit objects. The object graph of commit objects tracks a happens-before ordering of versions of the set of runtime objects. In particular, the happens-before ordering of the versions is tracked by references that interconnect the commit objects within the object graph. The references between commit objects may reflect both sequential and causal relationships between the versions of the set of runtime objects. Furthermore, any given commit object representing a given version of the set of runtime objects may record the mutations that were applied to the set of runtime objects that derived the given version from a prior version of the set of runtime objects. By ordering the mutations to the set of runtime objects as version changes in a happens-before ordering, the system eliminates complexities in diagnosing concurrency issues that result from differences between the implicit memory ordering of different underlying hardware platforms supporting a computing environment, including threads and the runtime memory. As a result, any merge conflicts that occur when a program thread synchronizes the program thread's isolated copy of the set of runtime objects with the shared copy of the set of runtimes objects can be easily traced back to the shortcomings in a developer's source code that are causing the merge conflicts based on the object graph.

One or more embodiments allow for the implementation of concurrency safety via staged interactions with shared data structures in a wide range of computing environments by implementing these staged interaction in a manner that is backwards compatible with programs that predate the techniques described herein. In other words, the techniques disclosed herein can be used to provide concurrency safety via staged interaction during runtime of legacy programs without developers having to make alterations to the executable instructions of these legacy programs. The techniques described herein for concurrency safety are made retroactively applicable to legacy programs through the use of barriers that define logic for staging interactions. Before and/or during program execution, the system is configured to automatically insert these barriers into the executable instructions of a program instance where the barrier logic may be needed to perform the various task that facilitate staging interactions. With limited cost to program performance, these barriers may be used to perform any number of a wide variety of tasks that facilitate concurrency safety via staged interactions such as the creation of stage objects, redirection of program tasks from shared objects to staged objects, checks for concurrency issues and/or causality bugs, acquisition of locks on shared objects, synchronization of shared objects with staged objects, remapping of pointers, coloring of pointers, garbage collection, and/or other functions. By allowing for concurrency safety via staged interactions to be applied retroactively to preexisting programs, the applicability of the techniques described herein may be greatly increased.

One or more embodiments provide operational flexibility in implementing concurrency safety via staged interactions. For instance, a user may enable or disable the features that are used to implement concurrency safety via staged interactions in whole or in part. As a result, a user can enable concurrency safety via staged interactions in production environments where concurrency safety is prioritized over small reductions in program performance, and the user can disable concurrency safety via staged interactions in production environments where small increases in program performance are prioritized over concurrency safety. Additionally, or alternatively, the system may permit fine-grain configuration of concurrency safety via staged interactions at a task-specific level. For example, during development or maintenance of a program, a developer may trigger the staging of interactions for one program task by defining this program task using one token, and the user may circumvent the staging of interactions for another program task by defining this other program task using another token. As a result, a user can choose to implement concurrency safety via staged interactions for program tasks that warrant prioritizing concurrency safety over program performance, and the user can choose to bypass the implementation of concurrency safety via staged interactions for program tasks that warrant prioritizing program performance over concurrency safety.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

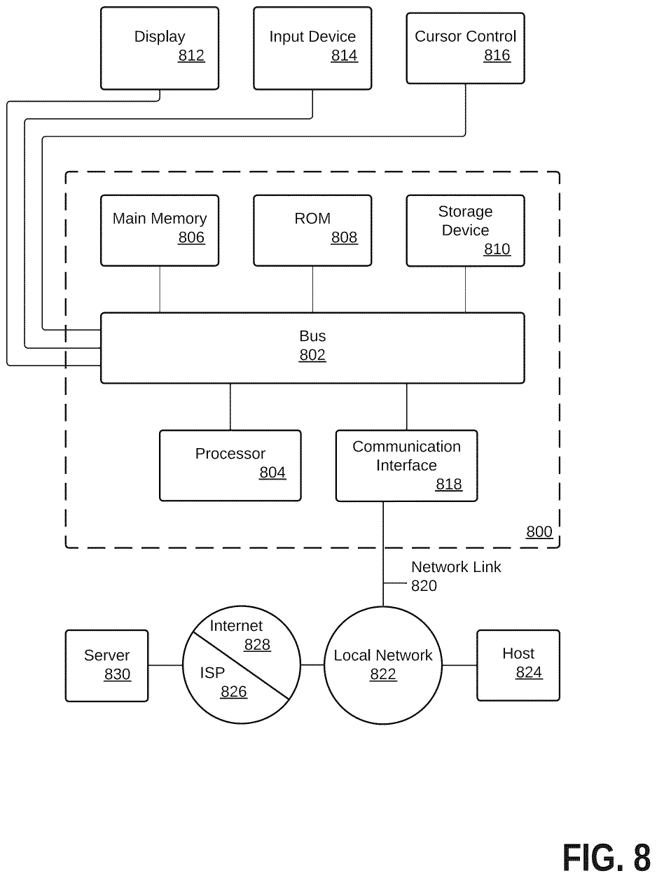

For example, FIG. 8 is a block diagram that illustrates a computer system 800 upon which an embodiment of this disclosure may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read-only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions included in main memory 806. Such instructions may be read into main memory 806 from another storage medium, such as storage device 810. Execution of the sequences of instructions included in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infrared data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, a computer program product includes instructions that, when executed by one or more hardware processors, causes performance of any of the operations described herein and/or recited in any of the claims.

In an embodiment, one or more non-transitory computer-readable storage media store instructions that, when executed by one or more hardware processors, cause performance of any of the operations described herein and/or recited in any of the claims. As used herein, the term “non-transitory computer-readable medium” refers to any tangible storage medium that stores computer-executable instructions for execution by one or more hardware processors in a computing device(s). The term “non-transitory” excludes transitory, propagating signals per se, such as carrier waves or other electromagnetic signals, but includes all forms of physical storage media.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A method comprising:
embedding a first value into a first set of one or more bits in a first pointer that refers to a first object comprised within a runtime memory area, the runtime memory area comprising (a) a first set of one or more objects that are associated with a first policy for executing requests and (b) a second set of one or more objects that are associated with a second policy for executing requests, wherein the first value indicates that the first object is either (a) comprised within the first set of one or more objects or (b) comprised within the second set of one or more objects;
receiving a request to manipulate a field of the first object from a program instance that is being executed by a thread, wherein the request is attempting to either (a) load a second pointer from the field or (b) store the second pointer to the field;
responsive to receiving the request, executing, by the thread, a barrier corresponding to the request, wherein executing the barrier comprises:
based, at least in part, on the first value embedded within the first set of one or more bits of the first pointer to determine if the first object is comprised within (a) the first set of one or more objects associated with the first policy for executing requests or (b) the second set of one or more objects associated with the second policy for executing requests; and
performing one of:
(a) based, at least in part, on determining that the first object is comprised within the first set of one or more objects, applying the first policy for executing requests to the request; or
(b) based, at least in part, on determining that the first object is comprised within the second set of one or more objects, applying the second policy for executing requests to the request,
wherein the method is performed by at least one device including a hardware processor.

2. The method of claim 1:
wherein applying the second policy for executing requests to the request is further based on determining that the second pointer does not refer to a second object comprised within the first set of one or more objects associated with the first policy for executing requests.

3. The method of claim 2:
wherein the request is attempting to load the second pointer from the field of the first object;
wherein the second pointer comprises a second set of one or more bits embedding a second value;
wherein determining that the second pointer does not refer to the second object comprised within in the first set of one or more objects is based on the second set of one or more bits embedding the second value.

4. The method of claim 1, wherein applying the first policy for executing requests to the request comprises:
generating a first staged copy of the first object in a staging area of the thread, wherein the first object is a shared object; and
performing one of:
(a) loading from the field in the first staged copy of the first object; or
(b) storing to the field in the first staged copy of the first object.

5. The method of claim 4, further comprising:
determining if (a) a first set of one or more mutations applied to the first object conflict with (b) a second set of one or more mutations applied to the first staged copy of the first object; and
performing one of:
based, at least in part, on determining that the first set of one or more mutations conflicts with the second set of one or more mutations, discarding the first staged copy of the first object; or
based, at least in part, on determining that the first set of one or more mutations does not conflict with the second set of one or more mutations, generating a second staged copy of the first object, wherein generating the second staged copy of the first object comprises merging the first set of one or more mutations with the second set of one or more mutations.

6. The method of claim 5, further comprising:
acquiring a lock on the first object;
updating the first object to match a state of the second staged copy of the first object; and
releasing the lock on the first object.

7. The method of claim 1:
wherein the first set of one or more objects are organized into a first layer of the runtime memory area, the first layer corresponding to the first policy;
wherein the first policy for executing requests is a safety-intensive policy;
wherein the second set of one or more objects are organized into a second layer of the runtime memory area, the second layer corresponding to the second policy; and
wherein the second policy for executing request is a performance-intensive policy.

8. One or more non-transitory computer-readable media storing program instructions that, when executed by one or more hardware processors, cause performance of operations comprising:
embedding a first value into a first set of one or more bits in a first pointer that refers to a first object comprised within a runtime memory area, the runtime memory area comprising (a) a first set of one or more objects that are associated with a first policy for executing requests and (b) a second set of one or more objects that are associated with a second policy for executing requests, wherein the first value indicates that the first object is either (a) comprised within the first set of one or more objects or (b) comprised within the second set of one or more objects;
receiving a request to manipulate a field of the first object from a program instance that is being executed by a thread, wherein the request is attempting to either (a) load a second pointer from the field or (b) store the second pointer to the field;
responsive to receiving the request, executing, by the thread, a barrier corresponding to the request, wherein executing the barrier comprises:
based, at least in part, on the first value embedded within the first set of one or more bits of the first pointer to determine if the first object is comprised within (a) the first set of one or more objects associated with the first policy for executing requests or (b) the second set of one or more objects associated with the second policy for executing requests; and
performing one of:
(a) based, at least in part, on determining that the first object is comprised within the first set of one or more objects, applying the first policy for executing requests to the request; or
(b) based, at least in part, on determining that the first object is comprised within the second set of one or more objects, applying the second policy for executing requests to the request.

9. The one or more non-transitory computer-readable media of claim 8:
wherein applying the second policy for executing requests to the request is further based on determining that the second pointer does not refer to a second object comprised within the first set of one or more objects associated with the first policy for executing requests.

10. The one or more non-transitory computer-readable media of claim 9:
wherein the request is attempting to load the second pointer from the field of the first object;
wherein the second pointer comprises a second set of one or more bits embedding a second value;
wherein determining that the second pointer does not refer to the second object comprised within in the first set of one or more objects is based on the second set of one or more bits embedding the second value.

11. The one or more non-transitory computer-readable media of claim 8, wherein applying the first policy for executing requests to the request comprises:
generating a first staged copy of the first object in a staging area of the thread, wherein the first object is a shared object; and
performing one of:
(a) loading from the field in the first staged copy of the first object; or
(b) storing to the field in the first staged copy of the first object.

12. The one or more non-transitory computer-readable media of claim 11, further comprising:
determining if (a) a first set of one or more mutations applied to the first object conflict with (b) a second set of one or more mutations applied to the first staged copy of the first object; and
performing one of:
based, at least in part, on determining that the first set of one or more mutations conflicts with the second set of one or more mutations, discarding the first staged copy of the first object; or
based, at least in part, on determining that the first set of one or more mutations does not conflict with the second set of one or more mutations, generating a second staged copy of the first object, wherein generating the second staged copy of the first object comprises merging the first set of one or more mutations with the second set of one or more mutations.

13. The one or more non-transitory computer-readable media of claim 12, further comprising:
acquiring a lock on the first object;
updating the first object to match a state of the second staged copy of the first object; and
releasing the lock on the first object.

14. The one or more non-transitory computer-readable media of claim 8:
wherein the first set of one or more objects are organized into a first layer of the runtime memory area, the first layer corresponding to the first policy;
wherein the first policy for executing requests is a safety-intensive policy;
wherein the second set of one or more objects are organized into a second layer of the runtime memory area, the second layer corresponding to the second policy; and
wherein the second policy for executing request is a performance-intensive policy.

15. A system comprising:
one or more hardware processors;
one or more non-transitory computer-readable media; and
program instructions stored on the one or more non-transitory computer-readable media which, when executed by the one or more hardware processors, cause the system to perform operations comprising:
embedding a first value into a first set of one or more bits in a first pointer that refers to a first object comprised within a runtime memory area, the runtime memory area comprising (a) a first set of one or more objects that are associated with a first policy for executing requests and (b) a second set of one or more objects that are associated with a second policy for executing requests, wherein the first value indicates that the first object is either (a) comprised within the first set of one or more objects or (b) comprised within the second set of one or more objects;
receiving a request to manipulate a field of the first object from a program instance that is being executed by a thread, wherein the request is attempting to either (a) load a second pointer from the field or (b) store the second pointer to the field;
responsive to receiving the request, executing, by the thread, a barrier corresponding to the request, wherein executing the barrier comprises:
based, at least in part, on the first value embedded within the first set of one or more bits of the first pointer to determine if the first object is comprised within (a) the first set of one or more objects associated with the first policy for executing requests or (b) the second set of one or more objects associated with the second policy for executing requests; and
performing one of:
(a) based, at least in part, on determining that the first object is comprised within the first set of one or more objects, applying the first policy for executing requests to the request; or
(b) based, at least in part, on determining that the first object is comprised within the second set of one or more objects, applying the second policy for executing requests to the request.

16. The system of claim 15:
wherein applying the second policy for executing requests to the request is further based on determining that the second pointer does not refer to a second object comprised within the first set of one or more objects associated with the first policy for executing requests.

17. The system of claim 16:
wherein the request is attempting to load the second pointer from the field of the first object;
wherein the second pointer comprises a second set of one or more bits embedding a second value;
wherein determining that the second pointer does not refer to the second object comprised within in the first set of one or more objects is based on the second set of one or more bits embedding the second value.

18. The system of claim 15, wherein applying the first policy for executing requests to the request comprises:
generating a first staged copy of the first object in a staging area of the thread, wherein the first object is a shared object; and
performing one of:
(a) loading from the field in the first staged copy of the first object; or
(b) storing to the field in the first staged copy of the first object.

19. The system of claim 18, wherein the operations further comprise:
determining if (a) a first set of one or more mutations applied to the first object conflict with (b) a second set of one or more mutations applied to the first staged copy of the first object; and
performing one of:
based, at least in part, on determining that the first set of one or more mutations conflicts with the second set of one or more mutations, discarding the first staged copy of the first object; or
based, at least in part, on determining that the first set of one or more mutations does not conflict with the second set of one or more mutations, generating a second staged copy of the first object, wherein generating the second staged copy of the first object comprises merging the first set of one or more mutations with the second set of one or more mutations.

20. The system of claim 19, wherein the operations further comprise:
acquiring a lock on the first object;
updating the first object to match a state of the second staged copy of the first object; and
releasing the lock on the first object.
